(19) United States
(12) Patent Application Publication
(10) Pub. No.: US 2009/0197551 A1
(43) Pub. Date: Aug. 6, 2009

(54) Billboard Receiver and Localized Broadcast System

(75) Inventors: Michael Paraskake, Vancouver (CA); Barry Shecter, New York, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Paper Radio LLC, New York, NY (US)

(21) Appl. No.: 12/025,878

(22) Filed: Feb. 5, 2008

(51) Int. Cl. H04B 1/18

(52) U.S. Cl. 455/179.1

(57) ABSTRACT

A billboard receiver comprising a layered structure may include a first layer comprising a receiver portion and at least a second layer defining a billboard portion. The receiver portion may include a radio receiver configured to be tunable to a selected one of a plurality of predefined radio programs via a corresponding one of a plurality of predetermined selection switch mechanisms. The billboard portion may include at least a first substrate comprising the second layer. The first substrate may be positioned to substantially cover at least one side of the receiver portion.

### FIELD OF THE INVENTION

Embodiments of the present invention generally relate to a programmable broadcast band receiver configured to operate with a corresponding localized broadcast system and also relate to a receiver having a housing comprised of substantially paper materials that may be used for advertising purposes.

### BACKGROUND OF THE INVENTION

While just about all major stadiums and sporting venues today have the necessary telecommunication infrastructure and communication capability of broadcasting live events to both outside viewers and listeners, limited or no communication capability is made to address the actual attendees or spectators within the venue. The majority of sporting events today are transmitted by a multiplicity of host broadcasters utilizing both television and radio mediums. These broadcasts are generally distributed and transmitted through one or more traditional FM and AM radio stations, satellite radio operators, as well as distribution through cable and television networks. However, at or within the venue's structure, many of these broadcast signals may be severely impaired or nonexistent due to building RF attenuation, poor RF signal propagation, or the lack of unobstructed line of sight signal requirements, as in the case of satellite radio. In some instances, the sporting event may even be blacked out to all local broadcasters and made only available to other regional networks thus leaving the stadium spectators without any media coverage of the event.

Moreover, while traditional AM and FM radio broadcasts may provide a spectator with the ability to listen to event coverage at a stadium or arena, standard radios do not provide a spectator with the capability to receive live event content from a variety of broadcast mediums including but not limited to satellite radio content, audio television content, and internet content being broadcast to one apparatus. As such, although a spectator may want to choose from several media broadcasts in a preferred network or a preferred broadcaster available from a single apparatus, such capability is not currently available in an apparatus employing standard broadcast band operation.

Conventional consumer FM and AM radio receivers typically receive radio signals from local broadcast radio stations that transmit their signal over an assigned and licensed frequency at or below a prescribed power level. All AM and FM radio broadcast transmissions must comply with strict federal regulations (FCC within the United States) that manage and control the AM and FM radio broadcast spectrum. AM and FM radio broadcast transmissions generally fall into two regulatory categories of either licensed or unlicensed operation. A determination as to whether a particular broadcast transmission is within the licensed or unlicensed category depends on such factors as the transmitting station's transmission power, antenna height, and the area or place from which the broadcasts emanate. Licensed systems involve the operation of both high and low power (LPFM (Low Power Frequency Modulation) and LPAM (Low Power Amplitude Modulation)) broadcast transmitters that are designed to provide coverage to a wide geographical area and require regulatory approval for legitimate operation. These licensed systems must adhere to strict government regulations such as, broadcast content, geographical coverage area, frequency of operation, interference, etc. Any increase in the licensed coverage area by the use of fill in repeaters or translators to selective locations that have poor signal coverage still requires regulatory approval.

Unlicensed (e.g., FCC part 15) operation in the U.S., for example, limits the transmitter power, the antenna length (gain) and even the power density measured at a predefined distance. By doing so these tight restrictions are purposely designed to limit unlicensed radio emissions to a confined coverage area whereby they may not interfere with licensed broadcast stations. In addition, unlicensed transmitters are not regulated as to what they can broadcast or re-transmit. Unlicensed transmitters are also not limited to where they can be placed and can be used to repeat or even frequency-translate off air stations, if desired. Although unlicensed AM and FM radio (Part 15 within the United States) transmission is purposely designed to cover a limited area, the propagation and signal characteristics of these two broadcast radio bands differ significantly in terms of broadcast coverage area and signal characteristics and are mainly due to their frequency of operation and modulation and demodulation process.

FM broadcast stations are authorized for operation on 100 allocated channels with 200 KHz spacing residing between 88.1 MHz and 107.9 MHz. FM radio broadcast transmission is generally considered an advantage over AM in that FM radio broadcast transmission can produce a high fidelity and high quality signal that is immune to crackling and other sources of impulse noise interference. Noise free reception by itself is not necessarily a measure of high-fidelity reception (Hi-Fi). High-fidelity reception generally requires that all audio frequency components in a musical passage can be transmitted for reproduction at the receiver. This requires that the width of the transmission channel, (bandwidth) be sufficiently wide enough to accommodate the majority of audible baseband spectrum between 50 Hz and 15 KHz. Also a phenomena in FM modulation known as capture effect can help to eliminate unwanted interference from a competing FM station that is residing on the same or close to the same operating frequency. Some of the drawbacks in FM radio include that broadcast frequencies are prone to the signal reflection phenomena (multi-path) whereby signal reflection off of obstacles may cause signal fluttering or complete cancellation. In addition, at very low power levels, Line of Site (LOS) operation is a very important factor as even small obstacles can attenuate these higher frequencies significantly and results in the fact that FM reception distances are only slightly greater than line of sight. For unlicensed FCC operation within the United States, at the maximum allowed signal power density, FM signals from 88 to 108 MHz generally propagate a distance of approximately 200 ft maximum and are subsequently lost into the RF noise floor of the band. This limited coverage area severely limits the type of applications for which unlicensed FM broadcast can be used.

Conversely, AM broadcast radio from 535 to 1705 KHz consisting of 117 carrier frequencies is not as susceptible to the signal reflection phenomena as in FM radio. AM broadcast frequencies are fairly immune to path obstructions and signal reflections and tend to have much better propagation characteristics because of the lower frequency of operation. At low power, unlicensed AM radio can provide a coverage area that this is much greater than its FM unlicensed counterpart operating at 88 to 108 MHz. Also, AM radio does not immediately drop off at the RF signal fringe areas, but gradually deteriorates into the noise floor.

A notable disadvantage of an AM radio broadcast system is the receiver's sensitivity to electrical impulse noise causing it to crackle from sources such as electrical power lines, motors, fluorescent and neon lights, and other industrial and electrical equipment. In addition, AM radio does not provide as high fidelity as compared to FM radio where audio signal bandwidth is much greater and the provision for stereo sound can be also transmitted. Unlicensed AM (Part15) radio broadcasting is limited to 100 milliwatts of power with restrictions on size, height and type of antenna to ensure it does not exceed the specified field strength limits. Typical unlicensed AM operation can have an operational range that can be in excess of one mile to a high quality receiver thus providing superior coverage area as compared to unlicensed FM operation. These unlicensed transmission power levels are also referred to as microbroadcasting, and in radio terms, include the use of low-power transmitters (often part 15 or equivalent) to broadcast a radio signal over the space of a small mall or neighborhood. Microbroadcasters generally operate without a license from the local regulation body, but sacrifice range in favor of using legal power limits (for example, 100 mW for AM broadcasts in the United States). Both AM and FM bands are used, although AM again tends to have better propagation characteristics at low power.

Microbroadcasting is also used by schools and many businesses to serve just the immediate campus of the operation. Well-known uses include automated tour guide systems, airport information services, and advertising applications such as car dealers and real estate agents which provide a low power unlicensed signal to be received by a driver's car radio system. In both AM and FM unlicensed radio systems, the coverage area is also very dependant on the sensitivity and selectivity of the receiver. In most applications the quality of the radio receiver cannot be controlled and therefore the coverage area may vary dependant upon the actual receiver being used. Other factors that may greatly effect coverage area is the actual topography of the surrounding the coverage area.

The past few years have witnessed a sudden and almost exponential growth in the demand of small portable electronic consumer devices. Many of these new personal devices such as CD and MP3 players, mobile phones and multimedia systems, have incorporated an FM and or AM radio receiver within them. This increasing demand to embed radio functionality into these newer and smaller devices has forced radio chipset manufactures to respond with a new generation of highly integrated single-chip low power consumption receivers. The micro architecture behind these new receiver chips allows them to be smaller, cheaper, and power efficient over their discrete and analog predecessors. Currently new single-chip AM/FM receiver designs can be implemented with a significant reduction in physical size, circuit complexity, and a sharp decline in the external and passive component count. In addition these new integrated radio chips provide superior AM/FM performance with better radio selectivity, sensitivity, image rejection and reliability while being fully programmable and alignment free with electronic digital tuning. Furthermore these new AM/FM radio chipsets can easily provide increased functionality by being used in conjunction with newer and advanced ultra low-power microcontrollers or PICs (Peripheral Interface Controllers). These combined breakthroughs in both microprocessor and radio chip-set microelectronics are allowing many new and multiple market applications in mobile consumer products.

However, operation of broadcast band receivers in low power environments may also create challenges whether AM or FM techniques are employed. As such, it may be desirable to develop an improved mechanism for local wireless communication. Moreover, by providing such an improved mechanism, other commercial uses may be feasible that had not previously been undertaken.

### BRIEF SUMMARY OF THE INVENTION

Accordingly, in order to provide a mechanism by which to address the challenges of low power AM or FM communication in a localized environment, embodiments of the present invention may capitalize on notable advancements in the design of a specialized personal radio receiver that may be easy to use, low cost, very thin, and wearable, which may provide satisfactory radio reception from both off air AM/FM radio broadcasts and low power unlicensed transmitters located within a particular area such as sporting and other such venues of various geographical sizes.

Embodiments of the present invention may also provide an unlicensed wireless broadcast system that can be fully scalable to any size venue. A further aspect of certain embodiments of the invention may be that embodiments can be deployed under various regulatory environments by using unlicensed power levels and thereby providing a universal broadcast solution. Furthermore, according to an exemplary embodiment, a personal receiver may be provided with preset station buttons specifically programmed to receive any local off air AM and/or FM stations and/or the re-broadcasted localized network transmissions that are exclusively associated with an event at a particular venue. According to another exemplary embodiment, re-broadcast transmissions may be limited to a confined area of the particular venue (e.g., a sports venue). Accordingly, advantage may be taken of the distinguishing differences in both modulation and RF signal propagation relating to AM and FM radio broadcasting for the deployment of a wireless broadcast system to personal receivers to be operated within various size sporting venues.

According to some embodiments, intelligent frequency switching capability may be provided to the personal receiver to enable operation in conjunction with an arrangement of multiple low power repeaters to effectively increase the overall coverage area being provided by the wireless rebroadcast network. As such, developments of newer FM and/or AM receiver and microprocessor technologies may synergistically provide ubiquitous signal coverage for a personal receiver within a large venue site.

In one exemplary embodiment, a billboard receiver having a layered structure is provided. The billboard receiver may include at least a first layer and a second layer. The first layer may include a receiver portion including a radio receiver configured to be tunable to a selected one of a plurality of predefined radio programs via a corresponding one of a plurality of predetermined selection switch mechanisms. The second layer may define a billboard portion. The billboard portion may include at least a first substrate comprising the second layer. The first substrate may be positioned to substantially cover at least one side of the receiver portion. In an exemplary embodiment, the billboard portion may also include a second substrate comprising a third layer. In such situations, the first and second substrates may be positioned substantially opposite of each other with respect to the receiver portion in order to substantially enclose the receiver portion. Of note, the predefined radio programs may be any of various different types of broadcast content that could, for example, be wirelessly programmed from a remote location. In this regard, for example, a predefined radio program may be any combination of off air radio station programming, low power AM or FM band content, aural television content (e.g., satellite, cable or the like), Internet content, recorded audio content, simulcast content, rebroadcast content, etc., that is provided at a designated frequency associated with a corresponding one of the selection switch mechanisms.

In another exemplary embodiment, a broadcast system is provided. The broadcast system may be a license-free broadcast system including a billboard receiver and a transmit portion. The billboard receiver may have a layered structure including a first layer comprising a receiver portion and at least a second layer comprising a billboard portion. The receiver portion may include a radio receiver configured to be tunable to a selected one of a plurality of predefined radio programs via a corresponding one of a plurality of predetermined selection switch mechanisms. The billboard portion may include at least a first substrate comprising the second layer. The first substrate may be positioned to substantially cover at least one side of the receiver portion. The transmit portion may be configured to transmit at least the plurality of predefined radio programs to the billboard receiver at a power density corresponding to license-free operation.

In yet another embodiment, a method for providing a billboard receiver is described. The method may include generating a billboard receiver having a layered structure and printing a visual advertisement for inclusion on at least one of the layers. The billboard receiver generated may include a first layer comprising a receiver portion. The receiver portion may include a radio receiver configured to be tunable to a selected one of a plurality of predefined radio programs via a corresponding one of a plurality of predetermined selection switch mechanisms. The billboard receiver may also include at least a second layer defining a billboard portion. The billboard portion may include at least a first substrate comprising the second layer. The first substrate may be positioned to substantially cover at least one side of the receiver portion.

Exemplary embodiments of the invention provide an ability to provide low cost personal receivers (e.g., housed in paper product or other like material), which may provide robust capability for reception of low power transmissions within a particular venue. In particular, embodiments may provide a low cost receiver capable of receiving multiple programs of content related to a particular event. In this regard, the multiple programs may correspond to multiple selectable preprogrammed switch mechanisms from which the user can select. Due to the low cost of such receivers, the receivers may be provided, for example, at no charge to guests of a particular venue. Moreover, due to the low cost paper construction, a thin design with a billboard-like surface may be provided to enable advertisement by a particular sponsor, service, retailer, etc. The decrease in cost of AM and FM radios may create substantially more value to the outside surface that houses the electronics of the radio than the value of the electronics themselves. Companies seek advertising space to advertise their brands at spectator events. The functionality of certain embodiments coupled with the entertainment value associated with providing a choice of multiple types of event content from a single source may provide an advertising vehicle for companies wishing to advertise their brands on thousands of spectators wearing an advertising billboard at an event. In some embodiments, pre-programmed audio advertisements may also be provided to persons using such a receiver upon power up of the receiver or channel switching. Additionally, a portion of the billboard like surface, or an additional paper portion may be provided to cover or house the receiver in order to provide a coupon or value added aspect to the housing of the receiver.

### BRIEF DESCRIPTION OF THE SEVERAL VIEWS OF THE DRAWING(S)

Having thus described the invention in general terms, reference may now be made to the accompanying drawings, which are not necessarily drawn to scale, and wherein:

FIG. 1 is a pictorial layout of billboard receiver and corresponding controls according to an exemplary embodiment of the present invention;

FIG. 2A is a component layout and sizing of billboard receiver according to an exemplary embodiment of the present invention;

FIG. 2B is a pictorial profile of billboard receiver according to an exemplary embodiment of the present invention;

FIG. 3 is a functional block and level diagram of billboard receiver according to an exemplary embodiment of the present invention;

FIG. 4 is a functional block and level diagram of broadcast link according to an exemplary embodiment of the present invention;

FIG. 5 is a functional block and level diagram of the repeater system according to an exemplary embodiment of the present invention;

FIG. 6A is a pictorial representation of a repeater configuration according to an exemplary embodiment of the present invention;

FIG. 6B is a pictorial representation of another repeater configuration according to an exemplary embodiment of the present invention;

FIG. 6C is a pictorial representation of yet another repeater configuration according to an exemplary embodiment of the present invention;

FIG. 7A is a flowchart of a receiver switching algorithm according to an exemplary embodiment of the present invention;

FIG. 7B is a continuation of a flowchart of the receiver switching algorithm according to an exemplary embodiment of the present invention;

FIG. 7C is a continuation of the flowchart of the receiver switching algorithm according to an exemplary embodiment of the present invention;

FIG. 7D is a continuation of the flowchart of the receiver switching algorithm according to an exemplary embodiment of the present invention; and

FIG. 8 is a network diagram representing the network and receiver operation according to an exemplary embodiment of the present invention.

### DETAILED DESCRIPTION OF THE INVENTION

Embodiments of the present invention relate to the re-broadcast and reception of existing off air program material that may exist on the FM band, the AM band, Satellite Radio, commercial television and even the Internet to a personal and proprietary FM, AM or AM/FM receiver. According to some embodiments, implementation of a localized wireless broadcast system may be provided. The localized wireless broadcast system may be deployed within sporting and other venues for the re-broadcasting of multiple event associated program sources to personal, inexpensive and/or sponsor branded receivers. A personal receiver, according to embodiments of the present invention, may appear and function as an advertising billboard that allows sponsors of sporting events with new advertising space to provide clear and constant views of their brands. The personal receiver (or billboard receiver) may be worn by spectators at sporting and other such events, which can receive aural source program material that can originate from, but is not limited to, stations on the AM broadcast band; the FM broadcast band, the Satellite Digital Audio Radio Service (SDARS), Internet Radio and the sound portion of commercial Television broadcasts, etc., which may be associated with the event itself. By way of example, and not limitation, embodiments of the invention may relate to both the unlicensed and licensed retransmission and reception of broadcast signals utilizing either the AM broadcast band, the FM broadcast band, or both. Embodiments may provide users of the billboard receiver with simple program selection options with respect to broadcast content associated with an event associated with a venue from among an assortment of predefined stations that may be distinctly labeled on the front of the billboard receiver, for example, by either the broadcasters name and/or logo. Once a user program selection is made, the receiver may automatically receive the branded station by tuning to either the locally broadcasted off air signal or to a re-broadcasted signal from the venue's localized broadcast network. The receiver may enable tuning to any of the predefined labeled stations regardless of the venue's actual geographic location.

While there may be other devices such as cell phones, conventional radio, or television devices that allow spectators to listen or watch an event, no other system combines the multiple broadcast of event coverage to a single spectator receiver with an advertising billboard to be worn by the spectators themselves as provided by embodiments of the present invention. Moreover, while a multitude of advertising space such as electronic score boards, fixed billboards, banners etc., may exist upon which companies may display their brands, embodiments of the present invention may provide companies with an inexpensive method of multiplying sizeable views of their brand at an event. In this regard, by inserting a radio receiver into an advertising billboard, the spectator may enjoy a choice of broadcast content while the advertiser is provided with an advertising method for their product via the multiple sizable display of products or corporate logos and via pre-recorded messages as achieved by embodiments of the present invention. As such, embodiments of the present invention may provide a receiving device that may capture various event contents from a plurality of broadcast sources, e.g., radio, TV, Internet, satellite radio, etc., and provide these choices to one audio receiving device for spectators.

Exemplary embodiments of the present invention may provide an unlicensed wireless distribution system that may allow seamless broadcast coverage through the use of AM and FM broadcast technology to proprietary receivers within a venue. Unlicensed low power AM or FM band transmission have strict government regulations in terms of operational power levels, antenna size, antenna types and height that purposely limits the radiated signal and hence coverage area. These imposed regulations result in a signal coverage area that is relatively small and severely limits the uses and applications for which unlicensed broadcast technology can effectively be used. On the other hand, a distinct advantage of unlicensed broadcast band transmission is that there are no imposed regulatory restrictions on the actual broadcast content that can be transmitted allowing it to be used both for personal and commercial use.

Embodiments of the invention may overcome the signal coverage limitation that is intrinsic to low power unlicensed transmission by devising a method that intelligently incorporates a multiplicity of these unlicensed transmitters to provide scalable and ubiquitous signal coverage to a large area or venue. Consequently, exemplary methods detailed herein could provide new opportunities for other commercial and personal applications. Furthermore, multiple low power unlicensed transmitters can be also linked wirelessly by means of unlicensed broadcast technology. Such an entirely wireless deployment may allow for quick and easy installation into difficult and strategic geographic locations that may be required in order to provide the proper signal coverage within the venue.

In some embodiments, a system comprised of both a proprietary receiver and wireless distribution system consisting of multiple dispersed repeaters is provided. The receiver may be programmed to specifically operate in conjunction with a pre-configured wireless network. The system may utilize inexpensive and unlicensed AM/FM broadcast band technology in the wireless re-distribution of program material to proprietary receivers operating within various size sporting venues. The proprietary receiver (e.g., the billboard receiver) may be able to operate in multiple modes (e.g., two) when tuning to a selected program via the user designated preset buttons. In this regard, embodiments of the present invention may provide for employment in connection with either or both of AM and FM distribution mechanisms.

A re-broadcast program may involve, for example, a wide area link transmitter broadcasting a signal on a single unoccupied AM band frequency that may be subsequently received by a multiplicity of repeaters. Each of the repeaters may include, for example, a commercial AM band receiver, associated audio baseband compensation equipment and a low power unlicensed FM transmitter. Such a wireless distribution and repeater system may take advantage of the AM band's inherent ability in providing greater signal coverage versus the FM band at lower unlicensed power levels. The lower AM band broadcast frequencies may virtually eliminate signal reflection problems, null areas and incur lower free space signal loss as compared to higher frequencies of the FM broadcast band. As such, the venue re-broadcasted program material may be transmitted on an unoccupied, clear and valid frequency within the AM broadcast band to a multiplicity of strategically placed low power repeaters within the venue.

Correspondingly, the repeater's receiver front end may be comprised of a commercial grade AM broadcast band receiver that provides high signal sensitivity and tight selectivity through the use of a narrow band IF filtering. These performance advantages may result in a higher signal to noise ratio (S/N) link being established to each of the repeaters. It may be considered imperative, in some situations, that this link frequency is as interference free as possible. As such, the link frequency may inherently have lower signal to noise S/N figures since the link may be an AM modulated link versus an FM modulated link. The repeater's AM receiver antenna may not be restricted to any size or gain as in the case of the unlicensed AM link transmitter and therefore could be a large ferrite antenna or external loop antenna with directivity that may provide a sufficient receive signal that could otherwise not be achieved by a typical AM hand held receiver.

Standard AM radio broadcast has an audio passband of 4.5 KHz and provides sufficient fidelity in passing sporting or other commentary that may originate from various sources such as the FM broadcast band, AM broadcast band, DARS Satellite band, Internet radio as well as aural portion of television and cable broadcasts. Therefore, the retransmission of baseband content from the AM receiver into a low power FM transmitter may not further reduce or degrade the audio bandwidth as the FM transmitter may provide an audio passband of 15 KHz.

The repeater, being comprised of an AM front-end receiver and an FM-output transmitter, may provide both a frequency and a modulation conversion. FM modulation offers not only an improvement in the S/N but also better discrimination against other interfering signals regardless of their source. FM receivers experience what is known as capture effect in demodulating the received signal. A signal from a second source residing on the same frequency and about half the signal level may virtually be inaudible and thus, only the near and higher powered signal may be heard. In contrast, in an AM transmission the near signal may be predominant while the second one may be heard as significant interference.

A potential advantage of using an FM modulated output on the repeater may also be realized in receiving the signal. In this regard, FM modulation offers not only an improvement in the S/N but also better discrimination against other interfering signals regardless of their source. The repeater system may, in some embodiments, avoid use of a simulcast arrangement whereby all repeaters are transmitting the same signal, on the same frequency, in the same general area and from more than one location to achieve broader coverage area and better penetration of a signal. Simulcast transmission may boost the coverage over a wide service area, but unfortunately the benefits are coupled with signal impairments that may be problematic and difficult to alleviate.

The quality of the RF signals generated by different transmitters when received by the proprietary receiver may depend on the signals, relative delays, magnitude, and relative frequencies. These signal discrepancies can introduce impairments such as RF phase cancellation, audio phase delay and beat tone distortion. Higher frequencies such as in the FM broadcast band may be subject to signal reflection off of building walls, metal structures, and other flat surfaces that are quite common within stadiums and other sporting venues. These reflections can cause RF phase cancellation which may occur when a delayed and reflected signal arrives out of phase with an incident signal at various receive locations depending on the local surroundings. In extreme cases of RF signal reflection, there may be a distinct possibility of complete RF signal cancellation whereby the receiver is receiving no RF signal even though it is within close proximity to the transmission source.

When signals are received from multiple transmitters, as in a simulcast scheme, severe and periodic signal cancellations may occur, especially in building complexes and open-overlap areas that result in excessive RF signal variation whereby an audible fluttering sound is heard at the receiver output. Both transmitter frequency offset and differential power are key parameters that must be meticulously adjusted to manage these distortions. To mitigate RF beat tone problems may involve the use of expensive high stability temperature controlled oscillators within the repeater's output transmitter. These accurate and stable oscillators may maintain sub audible frequency differences between transmitters eliminating any beat frequency tones the receiver may otherwise pick up due to oscillator tolerances and temperature variations among the multiple transmitters. Other frequency stabilization techniques such as GPS clock recovery may also be very expensive as each repeater transmitter may require its own GPS receiver and the fact that the venue might be indoors and not allow the reception of a satellite GPS timing signals.

To alleviate the many concerns and problems above, a more diverse approach may be utilized to enable reliable and economical reception of a signal from a multiplicity of low power transmitters that are used to cover a large geographical area. Such a system may involve a wirelessly linked network of multiple pre-configured repeaters operating in a cellular like fashion in conjunction with a proprietary receiver. The system architecture may utilize a multiplicity of inexpensive low power unlicensed repeaters to transmit the same program on different frequencies in the same general area and from more than one location to achieve the broader coverage area. The increased coverage area may be a result of utilizing two or more different frequencies and through the possible reuse of these frequencies.

In this regard, a multiple frequency approach may eliminate the numerous challenges associated with a simulcast transmission scheme as previously mentioned. As such, a group of strategically placed repeaters may operate on unoccupied FM band frequencies f₁ through fₙ and may be used to cover a number of areas in order to provide broadcast coverage over a wider area than the area of one individual repeater. Each repeater may fundamentally provide the same power and spherical coverage area known as a zone. The zone pattern may be restricted to a coverage area that is spherical in shape as unlicensed broadcast band transmission is limited to omni directional type antennas only. Every zone may then differ in frequency from any adjacent zone in order to eliminate common frequency interference that otherwise may be seen by the receiver between overlapping signals. There may also be at least one zone gap between zones which reuse the same frequency. The number of discrete frequencies required for a repeater network may be a function of both the venue's geographical coverage area and the repeaters frequency layout as needed in providing proper signal coverage. Familiar repeater coverage patterns that result in increasing coverage areas are triangular consisting of three frequencies, a square consisting of four frequencies, and a honeycomb structure consisting of five unique frequencies, etc. The exact frequency plan is pre-engineered to meet the coverage requirements of the venue or area.

The repeaters, by design, may be optimally spaced apart as to allow for a sufficient amount of signal overlap between them. This signal overlap area may provide the necessary signal level differences that may be exploited by the receiver in initiating a seamless frequency retune of the receiver's radio-chip when moving from one repeater zone to the next. The receiver may use several parameters, for example, in a proprietary algorithm used in determining as to when and what frequency it should retune to as it reaches the lower signal levels at the edges of a coverage zone.

Embodiments of the present inventions now may be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure may satisfy applicable legal requirements. Like reference numerals refer to like elements throughout.

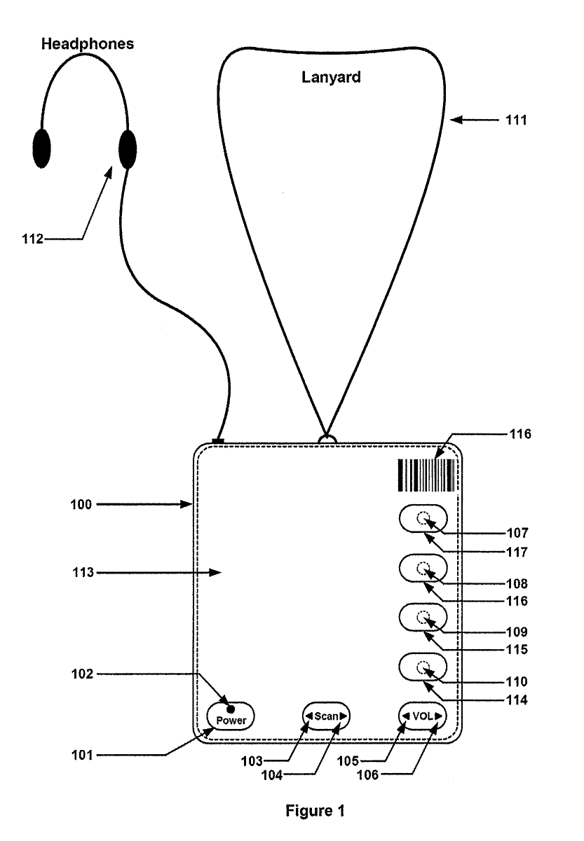

The physical appearance, layout and operational controls of a billboard receiver 100 according to an exemplary embodiment are fully depicted in FIG. 1. The billboard receiver 100 may be configured to provide a unique and multifaceted approach in the distribution of radio, branded advertising, marketing and sports entertainment by providing several different functions. In this regard, the billboard receiver 100 may include a radio receiver function that provides a spectator with a choice of various media broadcasts associated with an event the spectator is attending. Program choices may originate from a plurality of mediums such as, broadcast radio, satellite, television, the Internet and from the event itself. These multiple program choices may provide the spectator with a new dimension in sporting entertainment while viewing the event. The billboard receiver 100 may also include a billboard function. In this regard, the billboard function of the billboard receiver 100 may be to provide advertising space for broadcast, sporting, and other corporate sponsors who wish to have their branding and or logos graphically portrayed on the receiver. In addition to the visible and publicly viewed advertisements on the receiver, the billboard receiver 100 may also contain and provide “canned” or previously recorded audio advertisements to the individual listener that can relate to the sporting event, sponsors, channel content, as well as products and merchandise. The billboard function of the billboard receiver 100 may be provided, for example, by virtue of the fact that the billboard receiver 100 may be housed in a paper enclosure or casing that is comprised of at least two paper sheets between which components executing the radio receiver function may be disposed. At least one of the paper sheets (and possibly both) may therefore be utilized to provide advertisement space for sponsors, etc. In some embodiments one or more of the paper sheets may further include a coupon or other printed material that may be traded to a cooperating entity for a predefined item, discount, service or other consideration. As such, the billboard receiver 100 may be a relatively thin apparatus defined by paper sheets forming an outer housing in which the paper sheets provide a printable surface.

The billboard receiver 100 may be a promotional personal device intended to be worn around a spectator's neck at sporting or other events and may be held in place by a lanyard 111. The billboard receiver 100 may be uniquely shaped and sized to accommodate both the operational electronic controls 101, 103, 104, 105, 106, 107, 108, 109, and 110 of a proprietary radio receiver as well as the advertising and marketing space 113, 114, 115, 116, 117 for a multiplicity of sponsored branded companies. The receiver's light weight and extremely low profile may make it comfortable and easy to wear while displaying and promoting corporate brands and advertising to mass market audiences such as sporting events.

The receiver's physical aspects, shape, size, and layout are so designed as to allow clear, legible and concise advertising on space 113 provided by the receiver packaging. The simplistic radio user controls 101, 103, 104, 105, 106, 107, 108, 109, and 110 may be purposely placed around the perimeter of the billboard receiver 100 generating the maximum usable advertising space 113 on the receiver packaging. By having the billboard receiver 100 exclusively designed to hang from the spectator's neck allows for the mass viewing of sponsor branded advertising that may be printed on both the front 113 and rear sides of the receiver packaging as well as the lanyard 111 itself.

An outside covering of the billboard receiver 100 may be comprised of a low cost paper material that may wrap around or otherwise enclose the front and back of the radio electronics of the billboard receiver 100. In this regard, the paper material may include a first sheet and a second sheet, which could be separate paper sheets or corresponding portions of in contact with the front and back sides of the billboard receiver 100. The front side of the receiver packaging may include embossed and/or labeled areas 101, 103, 104, 105, 106, 107, 108, 109, and 110 representing a position of user operable push buttons for controlling the device. The paper covering may also include specific areas 113, 114,115, 116, and 117 where printing and graphics space may be reserved for sponsor branded advertising and receiver station call signs. Areas 114, 115, 116, and 117 on the receiver covering may encircle the logos and/or call signs of user selectable stations from which the user can choose. The user selectable programs corresponding to areas 114, 115, 116, and 117 can originate either through existing off-air AM or FM broadcast stations or through the local re-broadcast network within the venue as defined in greater detail below. It is typically immaterial to the user (e.g., the spectator) as to what band or frequency the receiver is actually tuning to as the station buttons corresponding to areas 114,115, 116, and 117 represent a desired and designated program and not a selected frequency or band on the receiver.

The billboard receiver 100 may be powered on or off by the user via the depression of button 101, which may be labeled as “Power”. Subsequent to being powered, an LED 102 may illuminate indicating that the billboard receiver 100 is on and ready for use. The depressing of one of the imprinted areas 107, or 108 or 109 or 110 depicting the station logo and or call sign may enable the receiver 100 to intelligently tune to either a fixed frequency or to dynamically switch within a group of frequencies in order to receive and output the aural content of the selected station to user headphones 112. The user can adjust the desired audio level to the headphones 112 from the billboard receiver 100 by depressing an imprinted audio volume up 106 or volume down 105 buttons.

Scan up and down buttons 103 and 104, respectively, can be individually depressed while listening to an existing program to tune the receiver to the next available and detected off-air station within the radio band. The simultaneous depression of both the scan up 103 and scan down 104 buttons may allow the receiver to switch between the AM and FM broadcast bands. According to an exemplary embodiment, the outside packaging of the billboard receiver 100 may include, for example, an identifiable bar code 116 that may enable the user to return and exchange the expired billboard receiver 100 for special discounts and or pricing on sponsor branded products and merchandise (e.g., as a coupon). This may enable the reuse of the billboard receiver 100 whereby it can be repackaged with new branding and advertisements for another event.

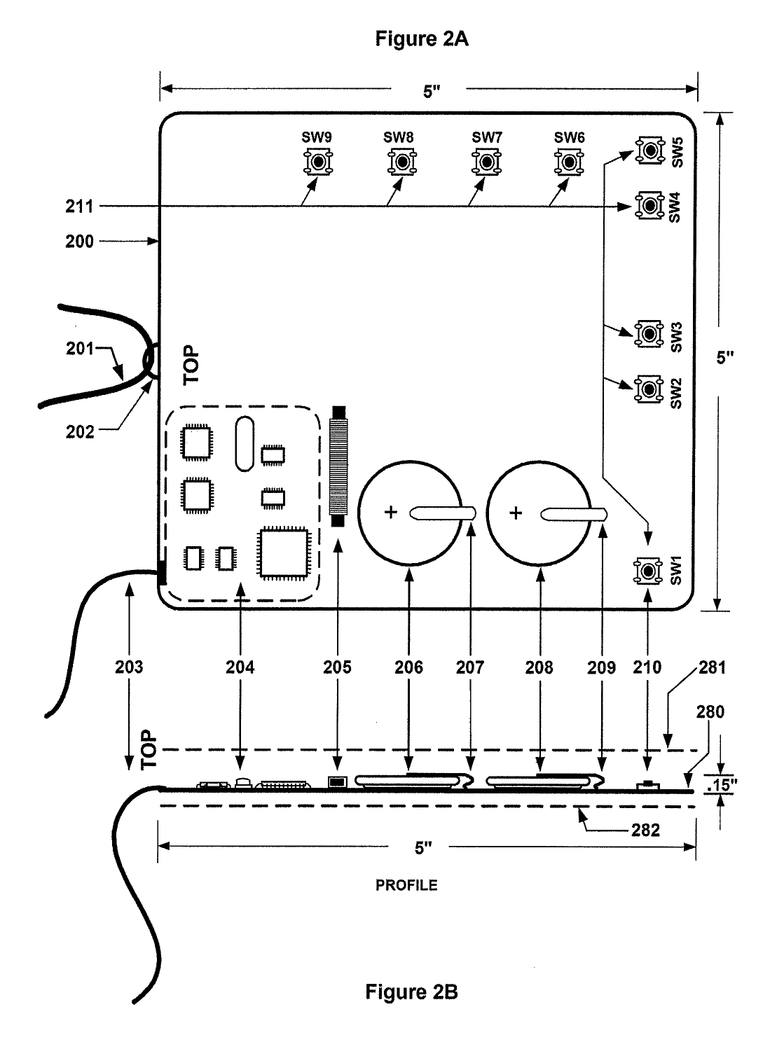

The electronics of the billboard receiver 100 may be embodied in a receiver portion, a physical profile and mechanicals of which are depicted, for example, in FIGS. 2A and 2B. In order for the device to be worn and function as both an advertisement billboard and radio receiver, the design may allow for simplistic operation as well as being completely observable. In this regard, the design may be such that the receiver has a panel style profile whereby it can be easily enclosed within a paper like covering which is folded around the entire device. The external paper like covering acts as both the receiver housing and as a billboard through the graphics and logos that are printed on front and rear exterior sides. The external paper like covering (which may form a billboard portion of the billboard receiver 100) may be comprised of first and second substrates positioned substantially opposite of each other with respect to the receiver portion in order to house the receiver portion. The first and second substrates may be either separate sheets or portions of a single sheet folded to house the receiver portion.

In an exemplary embodiment, all of the receiver components 201 through 211 may have an overall height that is lower than 0.15 inches, as illustrated in FIG. 2B. Such a low component profile may allow for the easy fitting of the paper like enclosure to be wrapped around the receiver portion which provides the essential and panel like flat exterior which may be useful for, e.g., sponsor branded advertising. As shown in FIG. 2B, the billboard receiver may have a layered structure. In this regard, for example, the receiver components 201 through 211 may be positioned in a first layer to form the receiver portion 280 of the billboard receiver. The billboard portion may include a second layer 281 and a third layer 282. The second layer may comprise the first substrate and the third layer may comprise the second substrate. As indicated above, the first and second substrates may each be comprised of a paper or paper like material. Thus, for example, the first and second substrates could be a foil, cardboard, polymer, fiber, thin plastic film or other material such as a plasticized material. Although FIG. 2B is not necessarily drawn to scale, it should be understood that the first and second substrates may define the overall height of the billboard receiver, which may be lower than 0.15 inches in an exemplary embodiment.

The billboard receiver's main board or PCB 200 may be comprised of a relatively inexpensive single sided PCB (printed circuit board) panel, for example, measuring about five inches high by about five inches wide and about 0.05 inches thick in size as shown in FIGS. 2A and 2B. However, any size that is desired may be employed. The size may be determined based on a balance between comfort for the user or spectator wearing the billboard receiver 100 and the provision of sufficient advertising space for an advertiser or sponsor. The PCB 200 may be made from a composite phenolic paper material known as FR2 or the like. This material may be used to mechanically support and electrically connect the receiver components 203, 204, 205, 206, 207, 208, 209, and 211 using conductive copper traces that may be etched onto the material. This material is typically used in very low cost and disposable consumer electronics equipment.

The receiver's electronic components 204 may include both integrated and passive components that may be mounted through low cost SMT (surface-mount technology) onto one side of the PCB 200. These components may be mechanically designed to have small metal tabs or end caps that allow them to be machine soldered directly onto the surface of the PCB 200. Moreover these SMD (surface mount devices) may be much smaller and can be one-quarter to one-tenth the size and weight of, and passive components can be one-half to one-quarter the cost of, through-hole parts. An alternative and lower cost mounting solution for the integrated semiconductors may be the use of a flip chip. Flip chips do not require any wire bonds and instead the final wafer manufacturing process step leaves solder bumps onto the chip pads whereby these components are connected and bonded with epoxy directly to the PCB board. The resulting and completed assembly may be much smaller than packaged solutions in both area and height.

Receiver function buttons 211, including SW1 through SW9, may be low-profile tactile push or dome type surface mounted push buttons or any other switch mechanism. The receiver function buttons 211 may have, for example, a sharp click feel with a positive tactile feedback. The buttons may require a user operational force on them that is greater than what is being exerted by the external paper packaging in order to register an input. The buttons may be surface mounted onto the PCB panel 200 as shown by 210 in FIG. 2B. A loop fastener 202 is attached to the top center of billboard receiver 200 and allows a lanyard 201 to be strung through it which is ultimately placed and worn around the spectator's neck.

A headphone line cord 203 may be directly connected and soldered to the PCB 200 in order to maintain the receiver's low profile by eliminating both the size and cost of a headphone jack. The headphone line cord 203 may be RF coupled into the FM portion of the receiver 204 and may function as an FM band antenna for the device. The AM antenna 205 may be a compact (e.g., about 1 inch long by about 0.25 inch wide by about 0.125 high) ferrite bar loop antenna that may be flush mounted against the PCB board 200. The coil may be wound around a high permeability ferrite bar thereby increasing the antenna's efficiency and reducing its size. The wire may be composed of a low gauge multi-stranded litz wire that improves overall antenna performance due to the higher Q and lower losses incurred at the AM broadcast band frequencies. The AM antenna 205 may be located away and perpendicular to any possible electromagnetically coupled interference that is being generated from the receiver's 204 high speed microcontroller bus. The ferrite coil may also be orientated in the horizontal plane to match and maximize the antennas inductive pickup of the incident horizontally polarization magnetic field (H plane) that originates from an AM broadcast band antenna.

The receiver's power source, according to an exemplary embodiment, may include a battery or batteries. In this regard, for example, the power source may include two individual inexpensive 3.0 volt low profile button batteries 206 and 208. The physical profile of these types of batteries may enable the receiver to maintain its slim width of about 0.15 inches. The two batteries 206 and 208 may be connected in parallel and provides the required 3.0 volt supply and current needed to operate the receiver electronics 204 for several hours. The batteries may be firmly held in place by two metallic tabs 207 and 209 which apply a sufficient force against the batteries to press the batteries against a contact point on the PCB board 200.

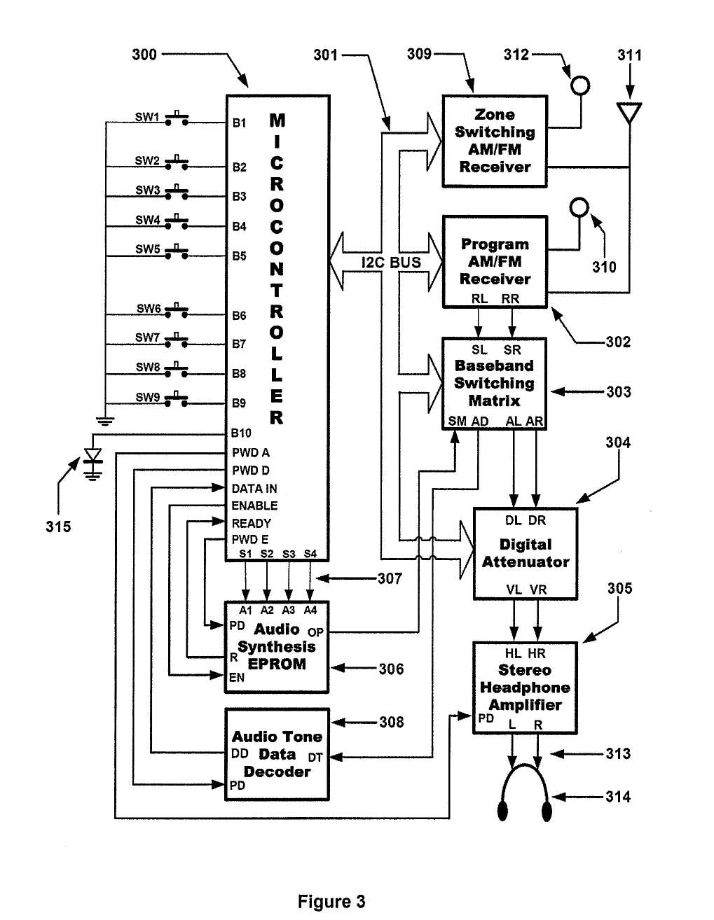

FIG. 3 depicts a functional block and level diagram of electronics of the receiver portion of the billboard receiver 100 as it is characterized within an exemplary embodiment. The block and level representation depicts only one electrical representation of many possible variations whereby it could be accomplished with alternative hardware by one whom is knowledgeable and skilled in the art of receiver design and microprocessor implementation.

The billboard receiver 100 may include a low cost single chip microcontroller or PIC (Peripheral Interface Controller) 300 which may control the main operation and functionality of the billboard receiver 100. The microcontroller based architecture may provide an inherent operational flexibility that may enable the receiver, e.g., through proprietary firmware, to intelligently operate in multiple receiver modes that may allow the billboard receiver 100 to reliably receive both licensed high power off-air and unlicensed low power broadcasts. As used herein the term unlicensed operation or unlicensed broadcast should be understood to correlate to operation below a power density or field strength above which there may be restriction or licensing required. As such, unlicensed operation may be defined as relatively low power operation thereby enabling license free operation.

The microcontroller 300 may hold a sufficient amount of self contained non-volatile flash EPROM and RAM to efficiently execute and run the internal operating code for the billboard receiver 100. For example, proprietary firmware may be provided to manage the integrated peripheral components within the billboard receiver 100. Internally, the billboard receiver 100 may use a simplified communication serial protocol known as I2C or IIC which stands for Inter-Integrated Circuit. I2C is an industry standard adopted by dozens of device manufacturers which use a high integrity and robust two-wire serial bus for control purposes which greatly simplifies and miniaturizes the communication interface between devices. All communication messages are typically eight bits wide and a master slave hierarchy is typically utilized in accessing the bidirectional interface bus.

The microcontroller 300 may use I2C communications bus 301 and protocol to serially address and communicate with a single-chip AM or AM/FM radio 302, a baseband switching matrix 303, a digital attenuator 304, and an optional zone switching AM/FM radio chip 309. The microcontroller 300 may also use several I/O control lines to handle devices including the Audio Voice Synthesis PROM 306, the Audio Tone Data Decoder 308, the Stereo Headphone Amplifier 305, the Power on indicator 315 and the receiver function buttons SW1 through SW9 connected to the microcontroller 300 itself.

The receiver function buttons SW1 to SW9 inclusive may be low profile normally open single pole single throw momentary contact push buttons. These function buttons are correspondingly connected to the microcontroller's 300 I/O lines B1 through B9 and may be normally floating or pulled high in the idle un-depressed state. Upon user depression and release of any selected function button SW1 through SW9 causes the corresponding interrupt driven I/O line B1 through B9 to momentarily go low and subsequently invoke an associated subroutine within firmware to perform the requested function.

User function button SW1 may operate with interrupt I/O line B1 to turn the power on and off for the receiver. Upon receiver power up through the user depression and release of SW1, triggers a momentary interrupt on I/O line B1 that as a result takes microcontroller 300 out of a low power sleep mode. Microcontroller 300 afterward may issue a logic one high state level to I/O line B10 illuminating LED 315 which may provide a visual indication that the receiver is in the “on” state. Microcontroller 300 may subsequently run a routine that powers on the rest of the receiver circuitry by sequentially addressing and sending single-chip radio 302, Baseband Switching Matrix 303, and Digital Attenuator 304 power wakeup commands via the I2C bus. Further receiver circuitry such as a Stereo Headphone Amplifier 305, Audio Tone Data Decoder 308 and the Audio Synthesis PROM may also be awakened from a powered down state as the microcontroller 300 raises corresponding I/O lines PWD A power-down amp, PWD D power-down decoder, and PWD E power-down EPROM, which connect directly to their respective PD power down input signals.

In an exemplary embodiment, function buttons SW2 through SW5 may operate with I/O interrupts B2 through B5 and provides four possible program choices from which the user may select. Function buttons SW2 through SW5 may provide the user with an assortment of broadcast content choices that may be clearly identified by logos and or call signs on the receiver's outside paper covering. This predefined program selection may eliminate a need for the user to relentlessly tune in search of a program and may make it unnecessary for the user to be aware of the receiver's actual tuned frequency or band of operation. Furthermore, program content represented by each of the content buttons SW2 through SW5 may be electronically assigned and preprogrammed through the microcontroller's firmware 300 to specifically tune single-chip radio 302 to either a known and predetermined single fixed frequency or to agile tuning scheme that is programmed to dynamically switch between frequencies assignments from within a group of prearranged and known frequencies based on specific received signal conditions.

The scan function buttons SW6 scan down, and SW7 scan up utilize I/O interrupts B6 and B7, when either is subsequently depressed and released, calls upon a subroutine residing within the firmware for microcontroller 300 to address and issue an I2C command to single-chip radio 302 to invoke a corresponding and autonomous manual frequency scan up or frequency scan down in searching for the next available station that exists in the current band of operation.

User function buttons SW8 and SW9 may provide the listener with audio level controls that may be continuously variable in adjusting the receiver's audio output level to the headphones 314. Function buttons SW8 volume up and SW9 volume down may interface directly with corresponding I/O interrupt lines B8 and B9. Upon user depression of either button SW8 or SW9 a program interrupt may be triggered and a subsequent subroutine may be initiated within the firmware of microcontroller 300. The program subroutine may address Digital Attenuator 304 via the I2C bus 301 whereby the program subroutine may further send the user selected and corresponding volume up or volume down binary control values for so long as button SW8 or SW9 remain depressed. The digital control values may correspondingly either increase or decrease the audio levels allowed to pass through the digital attenuator 304 on both audio channels simultaneously from input DL to output VL and from input DR to output VR. The subroutine may also employ an algorithm whereby binary control values may be incremented or decremented logarithmically over time while function buttons SW8 or SW9 are being depressed continuously, thus providing a more even and linear increase or decrease in the volume level changes being presented to the listener.

The microcontroller 300 may utilize the serial I2C bus 301 and the standard I2C command set to send a multiplicity of coded instructions for electronically tuning the single-chip radio 302. These I2C instructions can control a number of operational parameters within the integrated radio chip 302. The parameters may include such basic settings such as the radio chip's intended band of operation, the required de-emphasis, the IF bandwidth, the receiver front end gain, the receivers tuned frequency, the AGC speed, autonomous search, audio muting, output ports and even the local oscillator hi-side or lo-side injection scheme. Correspondingly the radio chip 302 can supply, upon receipt of an I2C request command from the microcontroller 300, its current status information such as the RSSI (received signal strength indicator), receiver frequency lock, stereo or mono mode, and station found indicator. Microcontroller 300 may digitally tune the frequency of single-chip radio 302 through bidirectional communication sessions on the I2C bus 301 and whereby single-chip radio 302 may subsequently output the demodulated audio content to baseband signal outputs RL, radio left channel and RR, radio right channel signals.

The single-chip radio 302 may utilize a low profile ferrite loop-stick antenna 310 for receiving the AM broadcast band while the headset line cord 311 may function as the FM Band antenna. Upon turning the receiver off through the depression and release of the power button SW1 may subsequently cause an interrupt on I/O line B1 that may enable the microcontroller 300 to issue an I2C power down command over the I2C bus 301 setting the single-chip radio 302 into a low power sleep mode in order to conserve battery life.

Microcontroller 300 may utilize the I2C bus 301 to control and route multiple audio input and output signals through Baseband Switching Matrix 303. The Baseband Switching Matrix 303 may be comprised of various combinations of electronic analog type switches which may be selectively controlled through programmed firmware residing within the microcontroller 300. The baseband inputs to the switching matrix 303 may be comprised of the audio input signals SL, signal left, SR signal right and SM signal mono. Signals SL and SR input the baseband signals originating from single-chip radio 302 as RL, receiver left and RR receiver right program audios. Signal SM, signal mono may input the audio signal originating from the Audio Synthesis PROM 306 as monaural output MO.

The outputs of the switching matrix may be comprised of audios AL and AR that connect to Digital Attenuator 304 and audio output AD connecting to Audio Tone Data Decoder 308. Upon user selection of a program by depressing one of the preset program buttons SW2, SW3, SW4 or SW5, microcontroller 300 may address and issue an I2C command to the baseband matrix switch 303 to select a corresponding SM audio input from the Audio Voice Synthesis PROM 306. The microcontroller 300 may subsequently submit an I2C command to the baseband switching matrix 303 enabling the baseband switching matrix 303 to switch the selected input SM audio source to both the AL and AR outputs of the matrix switch 303. Microcontroller 300 may now, for example, select a pre-programmed audio advertisement by asserting a four bit binary address on bus 307 via I/O control lines S1, S2, S3, and S4 that correspondingly connect to address input lines A1, A2, A3, and A4 on the Audio PROM 306. The asserted binary address values A1 A2 A3 and A4 represents the starting address of a block of internal and contiguous memory locations that contain the audio playback data that corresponds to the user depressed program buttons SW2, SW3, SW4, and SW5. Microcontroller 300 afterward may raise the Enable I/O signal that likewise connects to the EN enable input signal of the Audio PROM 306, permitting the stored data block associated with the depressed program button to be sequentially read, converted, and outputted as an analog audio signal appearing on the OP line of PROM 306. The audio signal advertisement may subsequently be passed through Baseband Switching Matrix 303, Digital Attenuator 304, and Headphone Amplifier 305 and into the user headphones 314. More than one PROM address can be assigned to each of the corresponding preset buttons SW2, SW3, SW4 and SW5 allowing for a rotation of different audio advertisements for each time a specific program button is re-depressed.

In the audio playback mode, when an advertisement is being played, I/O interrupts B2 through B7 may be disabled such that the user is not allowed to re-select an alternate program until the audio advertisement has been completely played out from the current memory block of PROM 306. Upon completion of the audio playback advertisement Audio PROM 306 momentarily triggers a low level signal onto the R reset signal line connecting to the Ready I/O line of the microcontroller 300. This Ready I/O signal instructs the microcontroller 300 firmware to address and send I2C commands to the Baseband Switching Matrix 303 for deselecting the SM audio input and reselecting the single-chip radio audio's RL and RR being inputted on SL and SR of the Audio Switching Matrix 303. Subsequent commands may be sent from the microcontroller 300 to switch input SL onto output AL and input SR onto output AR within the Baseband switching matrix 303. This switching configuration provides an audio path for the program receiver chip 302 to output both audio channels RL and RR into Digital attenuator 304, Stereo Headphone Amplifier 305, audio line cord 313, and finally into the receiver headphones 314.

Microcontroller 300 also sends an I2C command to the baseband switching matrix 303 to have it switch inputs SL and SR that connect to program receiver 302 output signals RL and RR to the common output signal AD, analog data on the switch matrix 303. This command is subsequently sent after microcontroller 300 issued the I2C commands that connected the SM audio source to both the AL and AR outputs of the matrix switch 303 that allowed the initial audio greeting advertisement to be switched to the digital attenuator 304, headphone amplifier 305, audio line cord 313 and headphones 314 upon initial power up. During the audio playback mode of the greeting prompt from Audio Synthesis PROM 306, audio input sources SL and SR remain switched to output AD. The matrix switch 303 output signal AD is connected to the DT data tone input of Audio Tone Data decoder 308.

Microcontroller 300 at this time sends the necessary I2C tuning commands instructing receiver 302 to tune to the last standard (highest frequency 1710 KHz) AM broadcast band frequency. Microcontroller 300 then waits for 80 msec which represents the tuning acquisition time of the radio-chip (50 msec) plus 20 msec representing the response time of the high speed tone decoder 308 and an additional 10 msec of required guard time. The received audio from program receiver 302 is now being sent to the DT signal input of Audio Tone Data Decoder 308. The function of Tone Decoder 308 is to sense and demodulate the any presence of AFSK (Audio-Frequency-Shift-Keying) tones that are being transmitted on the control channel that has been assigned to an unoccupied AM band frequency within the extended 1340 KHz to 1710 KHz frequency range (There are a greater number of clear and available frequencies in this portion of the AM broadcast band). The control channel transmits a signal that utilizes two-tone in-band ASFK signaling which resides in the baseband frequency range of 200 Hz to 3600 Hz and is allowed to pass through the NSRC passband filtering at the transmitter. Two-tone ASFK decoding provides superior decoding performance in low signal to noise environments. The Tone Decoder 308 will demodulate if present, the transmitted and received analog AFSK baseband tones and output the resultant serial bit stream on its associated DD (Decoded Data) output line to the Data IN of microcontroller 300. Subsequent to sending a new I2C tuning command to the program receiver 302, the microcontroller 300 waits 85 ms before attempting to read the DATA IN line for next 30 msec. If no data is detected within this 30 msec timeframe by the microcontroller 300 from the tone decoder 308, the microcontroller 300 issues another set of I2C commands to tune receiver 302 down to the next standard AM band frequency and subsequently waits the designated time before rechecking for serial detected data. The process continues until either the control channel has been detected or the all frequencies have been checked once within the mentioned spectrum (38 standard frequencies). If no control channel has been detected by microcontroller 302, a control channel bit is set within memory to have the switching algorithm use the pre-programmed EPROM preset button parameters. This mode can be utilized where the receiver is programmed to operate it a single geographic location or venue without the use of a control channel.

If control data is detected, the program receiver 302 has found and tuned to the control channel that is continually transmitting the associated program button parameters. The program receiver 302 will stayed locked to its currently tuned frequency as the microcontroller 300 will not send any further I2C tuning commands. The microcontroller 300 will asynchronously decode the demodulated serial data stream as the clock frequency sampling rate for the microcontroller 302 is a multiple higher than that of the incoming data rate. The decode frequency stability of the Tone Decoder 308 is maintained by internally dividing down the crystal clock frequency that operates the microcontroller 300.

The microcontroller 302 will find the start of a block of data by first identifying a pre-amble start word and then subsequently decode the preceding block of information which represents the program parameters for a single preset button. Each of the button program parameters are sent and encapsulated within their own data block. Parsing the button information into their own individual shortened data blocks increases the likelihood of a successful data transfer versus a single long data block in noisy RF environments.

As each block is decoded and verified, the associated button parameters are saved to its own designated location in the microcontrollers 300 RAM. A checksum procedure or an FEC code can be used for data stream error detection or correction. If the data detected by microcontroller 300 is determined to be corrupt (a bad block) it is discarded and the microcontroller 300 continues to decode the subsequently sent blocks as it will eventually receive the lost block again from the control channel as it continually repeats the transmission of the button parameters in an endless loop.

The microcontroller 300 stores each of the associated button parameters once in RAM until each of the preset button's designated memory location has been written to. Null button assignments are sent data signifying if a button is unassigned. Repeating and decoded block information is only checked against the current block information if stored in memory and is not overwritten unless it was detected to be different. This allows the receiver to be powered down and retain the button parameter information for the current venue of operation. A subsequent power-up in the same venue location will not require the data to be overwritten unless it has been changed or whereby the receiver has moved to different venue with different preset button parameters. Additionally the control channel frequency is also stored and saved in a designated memory location and will be the first frequency assigned to the program receiver 302 in the next power up control channel search sequence. If it is not detected again upon the next power up, the microcontroller 300 will start sending tuning commands again to the program receiver starting it from the highest AM band frequency. Additionally the firmware in microcontroller 300 sets a control channel check bit indicating to the switching algorithm to use the button parameters have been currently stored in RAM.

Once the Audio PROM 306 has completed its greeting play out, it sends an I/O interrupt READY signal to microcontroller 300. This I/O interrupt enables the user pre-set button I/O lines B2 through B5 and also instructs the microcontroller to subsequently send I2C commands to the switch matrix 303 to switch inputs SL and SR (from the program receiver) to outputs AL and AR (towards the headphones). This disables any audio content from being sent to the tone decoder 308 from the program receiver 302 and from the Audio PROM 306 to the headphones through the digital attenuator 304, headphone amplifiers 305 and subsequently to the headphones. Microcontroller 300 now sends a sequence of I2C tuning commands to re-tune program receiver 302 to one of the button preset frequencies or to an out of band frequency (either in the AM or FM band) thus switching it away from the previously tuned to control channel.

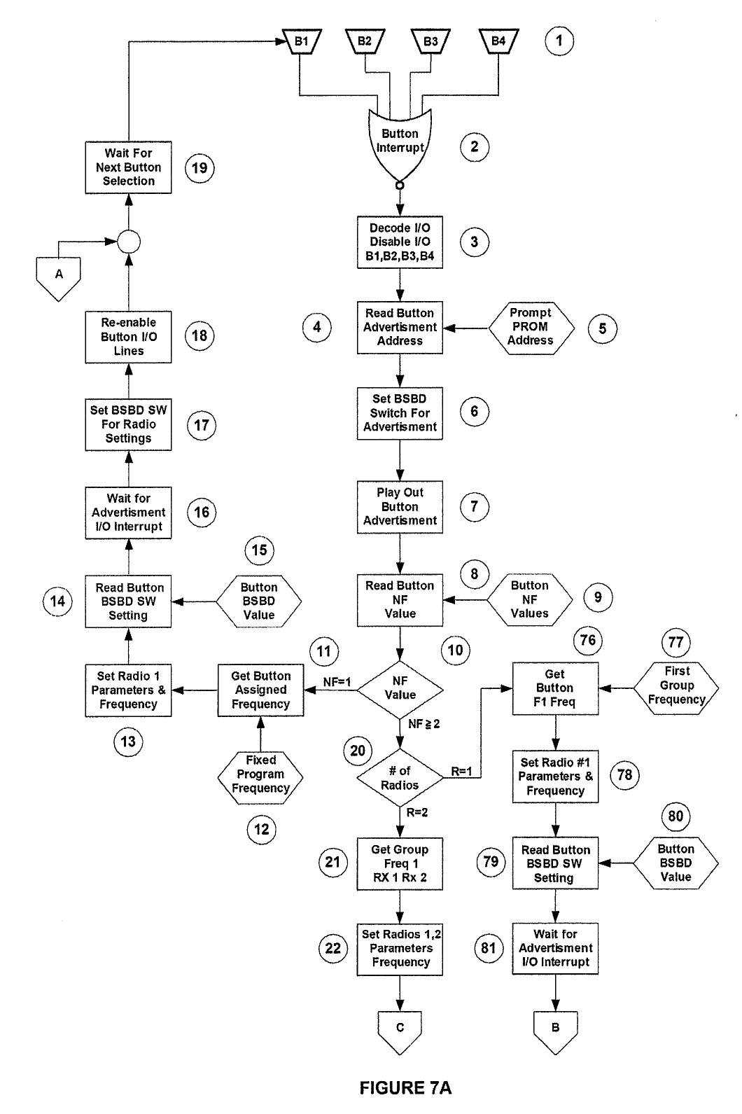

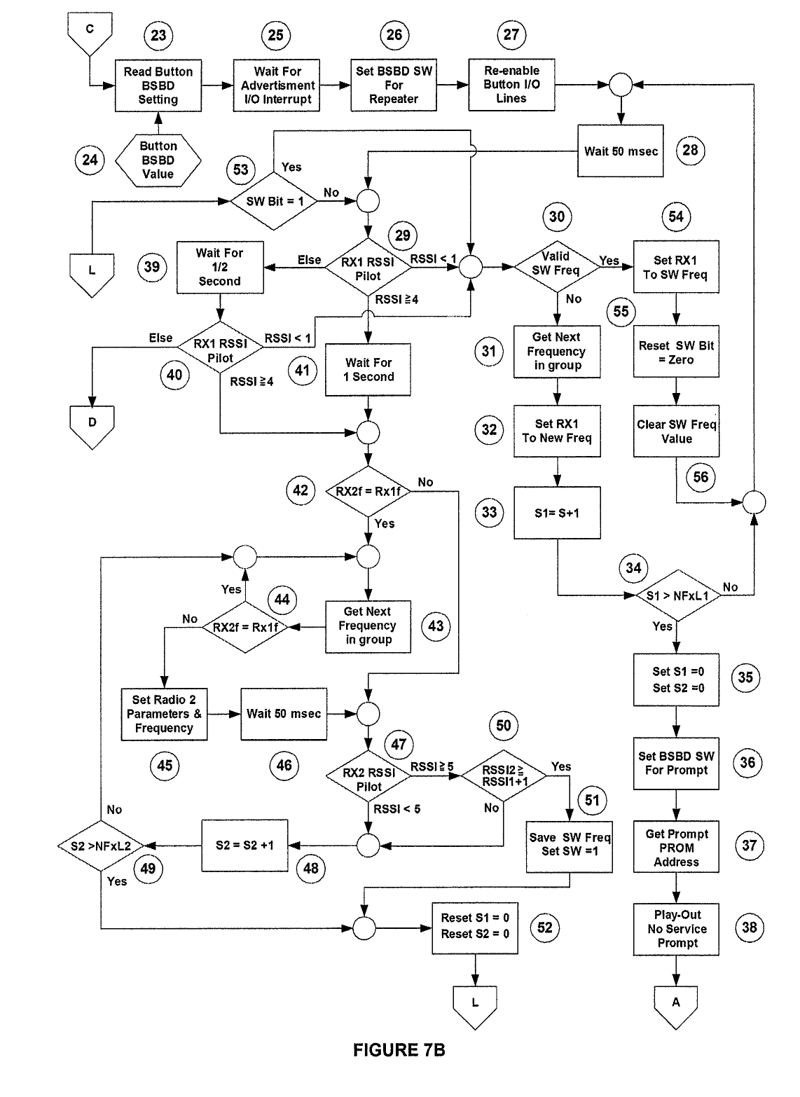

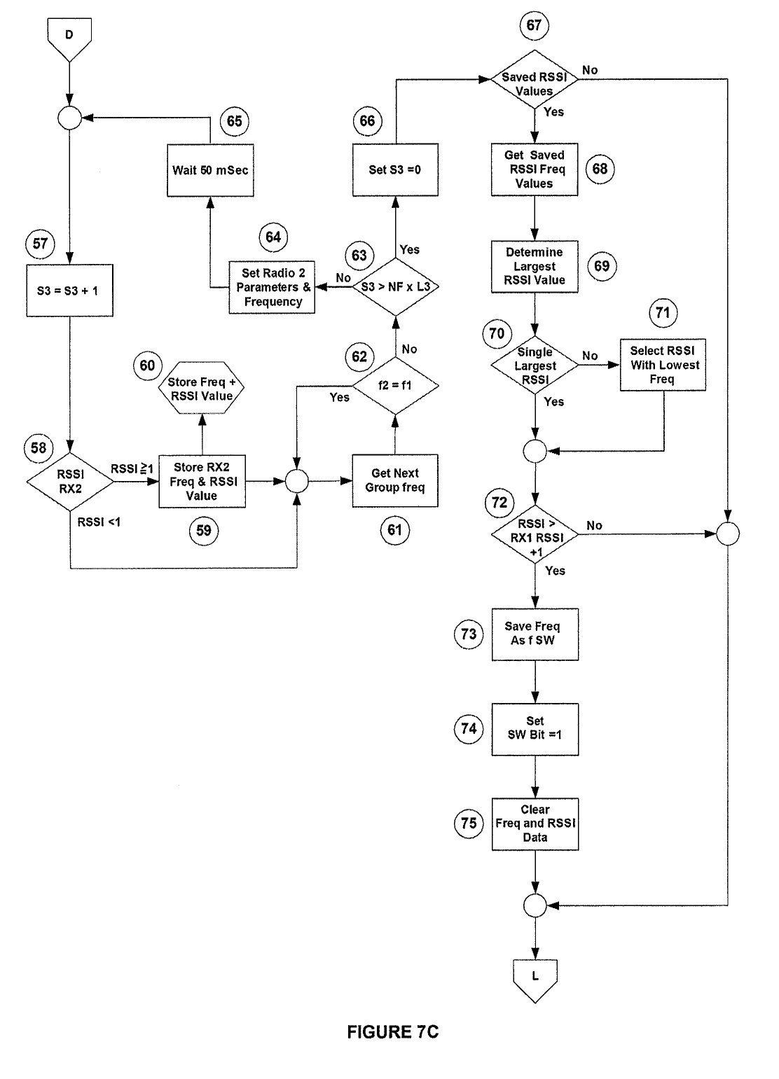

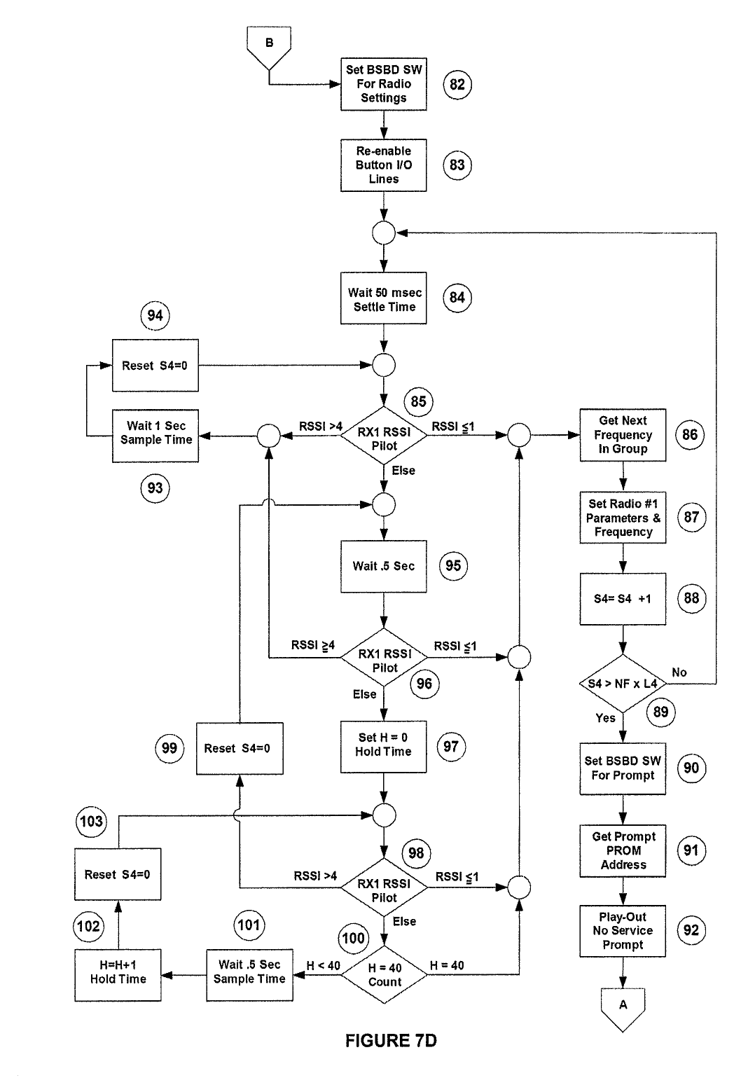

Microcontroller 300 may then address and send specific I2C tuning instructions to single-chip radio 302 that correlates to the selected program button that was depressed by the user. Microcontroller 300 tunes single-chip radio 302 to either a pre-assigned single fixed frequency or to an agile frequency that is allowed to dynamically switch within a group of pre-assigned frequencies through a proprietary switching algorithm. This multi-frequency receiver tuning algorithm uses various signal and timing parameters to determine the frequency of operation for single-chip radio 302 as described, for example, in FIG. 7. Both the single fixed frequency and the group frequencies may have been predetermined and programmed within the firmware of the microcontroller 300 to correspond with the received spectrum and repeater configuration within the area of operation for the receiver.

The microcontroller 300 once more may use the I2C bus 301 to control a Digital Attenuator 304 that may adjust the audio level that is originating from the radio chip 302 and Audio PROM 306. The two audio outputs AL and AR originating from the Baseband Switch Matrix 303 may provide audio program content that may be inputted to the Digital Attenuator 304. Upon user intervention, the through depression of either of the volume buttons SW8 or SW9 may subsequently cause a program interrupt on the corresponding I/O controls lines B8 and B9, whereby the microcontroller 300 may issue I2C commands that may initially address select the digital attenuator. Subsequent I2C commands may be sent to either increase (SW8 depressed) or decrease (SW9 depressed) the audio level allowed through the attenuator 304. The volume control algorithm may exponentially change the I2C command values being sent to the Digital Attenuator 304 providing a constant increase or decrease in listening level as the user holds down the selected volume button. Furthermore the last I2C volume command value is retained within a RAM memory location within the microcontroller 300 and therefore may return the last volume setting to the user after a power down power up sequence of the receiver. The adjusted audio level from the Digital attenuator 304 may be sent on audio outputs VL and VR to Stereo Headphone Amplifier 305.

The Stereo Headphone Amplifier 305 may include a pair of fixed gain low voltage audio amplifiers that may amplify and drive two independent channels of audio into the receiver headphones 314. The Headphone Amplifier 305 may accept the user adjusted audio levels AL and AR that is outputted from the Digital Attenuator 303 for amplification. These audio signals AL and AR may undergo separate but identical amplification within the Stereo Headphone Amplifier 305.

Each amplifier within the Stereo Headphone Amplifier 305 may have independent left/right shutdown controls, making it possible to optimize power savings when the receiver is powered down. Upon turning the receiver off, e.g., through the depression of the power button SW1, an I/O interrupt signal PWR DN A may subsequently be caused by the microcontroller 300 to go low, thereby putting stereo headphone amplifier 305 into a low power shutdown mode to preserve battery life on the receiver.

The Audio Voice Synthesis PROM 306 may be a low cost integrated circuit that stores an assortment of pre-recorded or canned advertisements. These audio advertisements may have been prerecorded and may be associated with the branded advertising, logos and venue markings displayed on the front and/or rear covers of the billboard receiver 100. The PROM 306 may include a sufficient amount of Flash or ROM memory in order to store several short duration audio advertisements that may be played out to the receiver headphones 314 upon the powering the up of the receiver by the depression of SW1 or when a program is selected by the user via the depression of SW2, SW3, SW4, or SW5 buttons. The PROM 306 may store the prerecorded audio by using an efficient sampling rate of 6 KHz with 4-bit ADPCM compression as these canned messages do no require hi-fidelity audio. This sampling and compression scheme may greatly reduce the amount of read only memory required to store the prerecorded audio advertisements.

User depression and release of power button SW1 may cause I/O interrupt B1 to turn on the receiver by having microcontroller 300 come out of low power sleep mode and setting the ON I/O line high, thus illuminating the power on LED indicator. Microcontroller 300 may subsequently address the Baseband Switching Matrix 304 and sends an I2C command to select and switch the monaural AS audio content from the Audio Voice Synthesis PROM 306 to both A1 and A2 audio outputs. Microcontroller 300 may then address Digital Attenuator 303 and send the last state (if power up previously) or the default 1C2 value for setting the receiver's initial volume level. Microcontroller 300 may then set PWR AMP I/O line high which may enable and power up Stereo Headphone Amplifier 305. Microcontroller 300 afterward may apply a binary address of 15 (all ones) via I/O address lines 307 to Audio Voice Synthesis PROM 306 selecting the internal memory location of the initial canned message to be played. Microcontroller 300 may subsequently apply a high logic level 1 to the ENABLE I/O line that starts the Audio Voice PROM 306 to output the initial message or advertisement to the matrix switch 304, followed by the digital attenuator 303 followed by Stereo Headphone AMP 305 and to the receiver headphones 312.

In an exemplary embodiment, the wireless broadcast link may include license-free AM Band communication equipment (e.g., relatively low power density) for the transmission of audio program material to a multiplicity of strategically placed unlicensed repeaters throughout a venue. The equipment takes full advantage of audio and modulation processing techniques in maximizing the quality of the broadcast signal. Several techniques for AM broadcast technology may be utilized in the baseband section of the link transmitter. The various arrangements of the license-free broadcast link may provide complete flexibility in providing scalable coverage area, wireless or wired deployment, frequency efficiencies, repeater or direct broadcast and band of operation to which may function with the firmware within the personal receiver (e.g., the billboard receiver 100).

A first exemplary configuration may allow the broadcast of a one monaural program signal that may be transmitted and rebroadcast by a plurality of individual repeaters including a single AM band receiver pre-tuned to frequency f1 Link and subsequently having its monaural baseband output signal inputted to both the right and left channels of a single license-free FM band stereo transmitter. The configuration may provide wireless and scalable deployment of multiple repeaters for the re-broadcast of a single audio program.

A second exemplary configuration may allow the transmission of two separate monaural program signals that are rebroadcast by repeaters consisting of two separate AM band receivers that are respectively tuned to two different broadcast link frequencies f1 Link and f2 Link and have their separate monaural baseband outputs signals inputted to the left and right input channels of a single license-free FM stereo transmitter. This configuration provides two separate programs to be repeated over a single FM Band frequency where limited broadcast spectrum availability may be an issue. The personal receiver firmware can be programmed to accommodate this configuration whereby the selection of a different program on the receiver by the user may not result in the retuning of the receiver radio frequency via the microcontroller. Instead the microcontroller may control a baseband matrix switch within the stereo receiver that selects between the demodulated left and right audio outputs of the radio. This arrangement may provide wireless and scalable deployment of multiple repeaters for the re-broadcast of two independent audio programs over a single FM band carrier.

A third exemplary configuration may be a direct broadcast operation whereby license-free f1 Link and license-free f2 Link are transmitting on the same frequency directly to the personal receiver without the use of repeater equipment. The link transmitters may be operating in a simulcast configuration whereby they are transmitting the same program information over the same AM band frequency at the same time. The transmitter carriers may be synchronized through a wired master slave clock configuration by carrying a differential timing signal over standard twisted pair cable. In this mode, the personal receivers may be programmed to directly receive a single link frequency without the use of a repeater network. This arrangement provides wired and scalable deployment of multiple transmitters for the direct broadcast of a single program over a single AM band carrier.

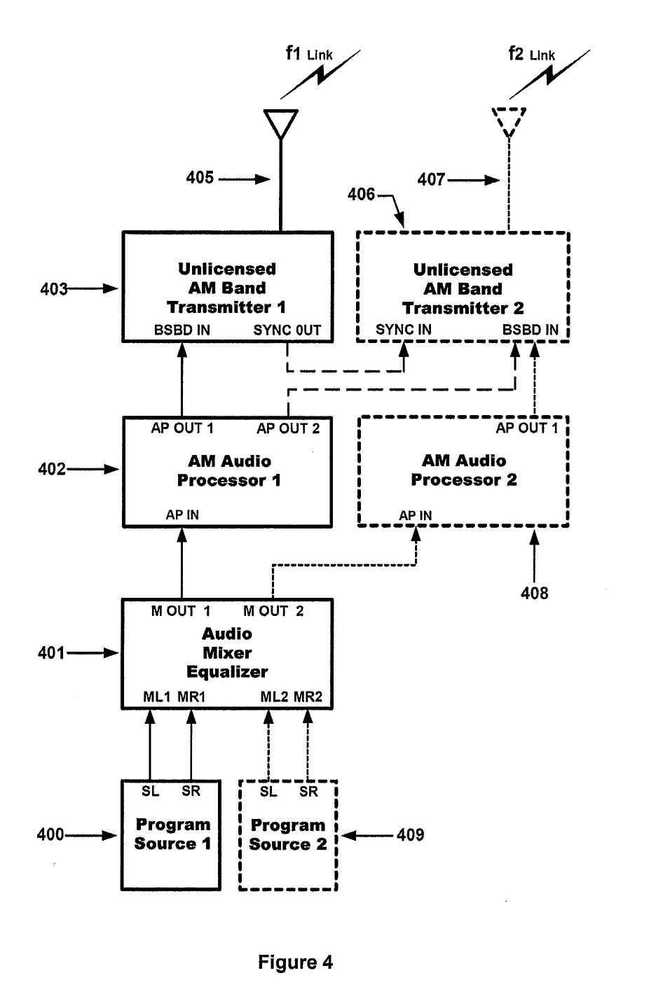

As per FIG. 4, audio source programs, including input 400 program 1 and input 409 program 2 can originate from a multitude of broadcast and media sources and can consist of an FM Band receiver, AM Band receiver, Satellite DARS receiver, Television audio demodulator, audio streaming from the Internet, or even local event program material from a microphone. The audio outputs SL and SR on both program sources 400 and 409 can be of a balanced or unbalanced transmission including a monaural or stereo signal that is inputted into the Audio Mixer Equalizer 401 on inputs ML1 mixer left source 1, MR1 mixer right source 1 and ML2 mixer left source 2, MR2 mixer right source 2. If the audio program sources 400 and 409 originate as a stereo signal, Audio Mixer Equalizer 401 may process the input signals though a summing amplifier and thus combine the left and right channels of each source into a single audio output MOUT1 mono output 1 for program 1 and MOUT2 mono output 2 for program 2. The Audio Mixer Equalizer may also provide impedance matching between the source audio device, audio frequency equalization and audio level compensation to the subsequent connected equipment. Audio Mixer 401 subsequently outputs audio MOUT1 and MOUT2 to their respective audio processor inputs APIN on Audio Processor 1 402 and APIN on Audio Processor 2 408 where the audio signals undergo several baseband processes.

AM Audio Processors 402 and 408 may provide audio signal processing specifically to enhance the quality of AM broadcast band transmission. To comply with regulatory issues in transmission, appropriate audio pre-emphasis may be inserted along with an NRSC stopband filter to reduce interference between adjacent on air channel stations. Other audio processes such as compression and peak limiting of the audio signal restricts program amplitude excursions to a peak level which represent 100 percent negative, and 100 percent to 130 percent positive carrier modulation. This audio processing technique, known as asymmetrical modulation, keeps the AM Band license-free transmitter 403 and 406 operating with a very high modulation index, thus maximizing the limited permissible output power level of the transmitter. Audio compression via dynamic range reduction may ensure that inherently low program levels are sufficiently amplified to a higher level making the transmission actually louder than the original program content.

The processed monaural baseband signal may finally be outputted from Audio Processor 402 APOUT1 to the BSBD IN of license-free AM transmitter 403. The transmitter 403 is a government certified (Part 15 within the United States) and fully compliant license-free AM Broadcast Transmitter that includes the antenna 405. The transmitter 405 amplitude modulates the baseband program signal and broadcasts it on an unoccupied AM broadcast band frequency.

According to the exemplary first configuration of broadcasting a monaural signal, the baseband audio may be processed from program source 1 400 to Audio Mixer Equalizer 401 to AM Processor 402 and finally to AM transmitter 403 where it may be transmitted via frequency f1 Link to a multiplicity of repeaters. According to the exemplary second arrangement, the broadcast of two separate monaural program signals may be enabled and two identical monaural broadcast chains may be included. The first audio program source 400 signals SL and SR may be inputted to ML1 and MR2 of Audio Mixer Equalizer 401 and subsequently outputted on MOUT1 towards APIN of Audio Processor 1 402 and finally into BSBD IN of license-free AM Transmitter 1 403 where it may be transmitted on frequency f1 Link. Second audio program source 409 signals SL and SR may be inputted to ML2 and MR2 of Audio Mixer Equalizer 401 and subsequently outputted on MOUT2 towards APIN of Audio Processor 2 408 and finally into BSBD IN of unlicensed AM Band Transmitter 2 406 where it may be transmitted on different frequency f2 Link. The SYNC OUT on transmitter 1 403 and SYNC IN on transmitter 2 406 may not be connected as the transmitters are on separate transmit frequencies.

According to the exemplary third configuration, a direct broadcast method may be provided where an audio signal is processed from program source 1 400 to ML1 and MR1 inputs of audio Mixer Equalizer 401 and subsequently outputted on MOUT1 to APIN of Audio Processor 1 402. Audio processor 1 402 may output identical program signals on APOUT1 and APOUT2 to BSBDIN input AM Band Transmitter 1 403 and AM Band Transmitter 2 406, respectively. Transmitters 403 and 406 may be configured to have F1 Link and F2 Link operating on the same frequency. The first transmitter 403 may provide a differential master SYNC OUT signal to the SYNC IN of the second transmitter 406 keeping the two transmitters 403 and 406 phase locked. The transmitters can be spaced up to a couple thousand feet apart due to the differential type signaling of the SYNC out signal used for synchronizing the RF carriers.

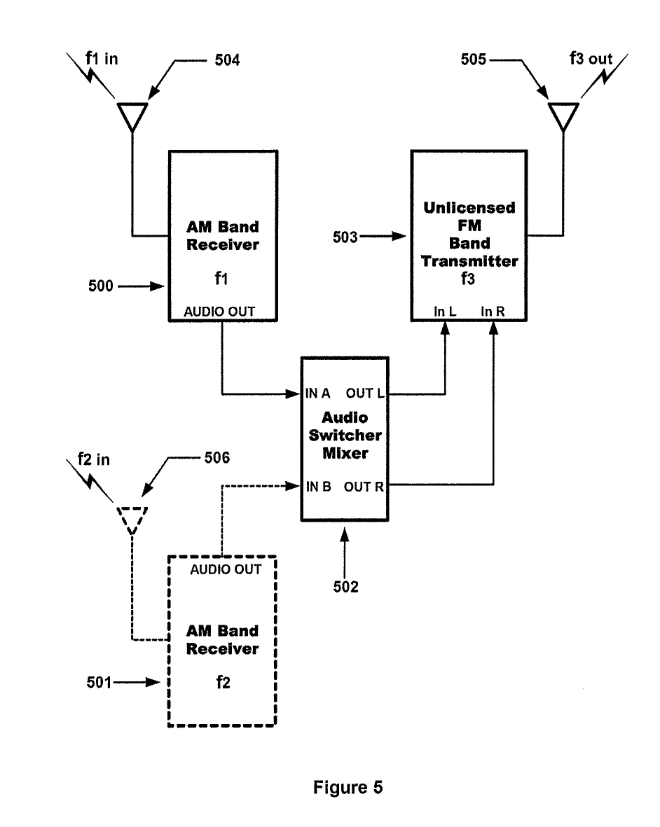

FIG. 5 describes a repeater system according to an exemplary embodiment. The wirelessly linked repeater design may provide scalable signal coverage area as well as easy and quick deployment of the equipment to strategic locations where it may be used. Coverage area is easily extended by adding additional repeaters that are appropriately placed and configured into areas that require reception.

The license free repeater 507 may include AM Broadcast Band front end and a license-free FM Stereo Broadcast band transmitter. AM band receiver 500 may be a commercial grade receiver that exhibits excellent sensitivity and selectivity over a conventional consumer grade radio. It may also incorporate a narrow band IF filter for minimizing any adjacent channel interference and thus provide a better signal to noise ratio of the demodulated signal. The receiver aerial 504 may not be subject to restrictions and can be of any size or gain as well as internal or external as it is a receive only antenna. These performance advantages can establish a high quality radio link from the AM broadcast link transmitter f1 in to the repeater's AM receiver 504 that can be in range of, for example, thousands of feet in distance. This extended link performance may enable easy deployment of license-free repeaters 504 in providing complete signal coverage to a venue.

Signal f1 in may originate from the omni directional broadcast link transmitter which may be transmitting a single audio program channel. Signal f1 in may be picked up with antenna 504 and received by AM receiver 500 which may be permanently tuned to the broadcast link frequency f1. The receiver 500 may demodulate the AM received radio signal f1 in and output the baseband program content from Audio out to IN A input A of Audio Switcher Mixer 502. Audio Switcher Mixer 502 may output the monaural program to both the OUT L output left and OUT R output right which is connected to the IN L and IN R of the license-free FM band stereo transmitter 503. FM transmitter 503 may transmit the monaural signals as if it were a stereo by having its 19 KHz stereo subcarrier enabled. The license-free FM transmitter may transmit through, for example, a legally permissible and omni directional antenna 505 on frequency f3 out that provides coverage to predefined area or zone. Repeater frequency f3 out is one out of a set of repeater frequencies (two or more) that may be associated with the program link broadcast f1 in. The total number of required repeaters per program is dependant on the coverage area and can exceed the program set of repeater frequencies through the implementation of frequency reuse.

The FM broadcast band is typically more crowded and has fewer unoccupied frequencies than that of the AM broadcast band. There may be certain venues that cannot support the multiple frequencies required in broadcasting several simultaneous programs due to lack of open frequencies in the FM band spectrum. As such, the repeater can be configured to transmit two separate and different audio programs utilizing one FM broadcast frequency.

Repeater 507 can be optioned with a second commercial AM Band receiver 501 that may receive a second source program from another broadcast link transmitter occupying an additional AM broadcast frequency. Signal f2 in may originate from a second omni directional broadcast link transmitter which may also transmit a second single audio program channel. Signal f1 in may be picked up with antenna 506 and received by AM receiver 501 which may be permanently tuned to the broadcast link frequency f2. The receiver 501 may demodulate the AM received radio signal f2 in and output the baseband program content from Audio out 501 to IN B input B of Audio of Audio Switcher Mixer 502. Audio Switch Mixer 502 may be configured to pass the first monaural received program from receiver 500 on input IN A to be switched to OUT L and subsequently to the IN L of FM stereo transmitter 503. Audio Switch Mixer 502 may also be configured to pass the second monaural receive program from receiver 501 on input IN B to be switched to OUT R and subsequently to the IN R of FM stereo transmitter 503. Transmitter 503 having stereo multiplex enabled, may now transmit two different audio program sources over one FM band frequency. Frequency grouped repeaters associated with the rebroadcast of these two programs may be configured in the same manner. All sets of repeaters 507 may utilize the exact same types of equipment and thus provide the same transmission characteristics such as, audio frequency response, delay, phasing, and transmitter deviation. This may ensure that when the personal receiver switches between repeaters that there is no audible change in the program sound.

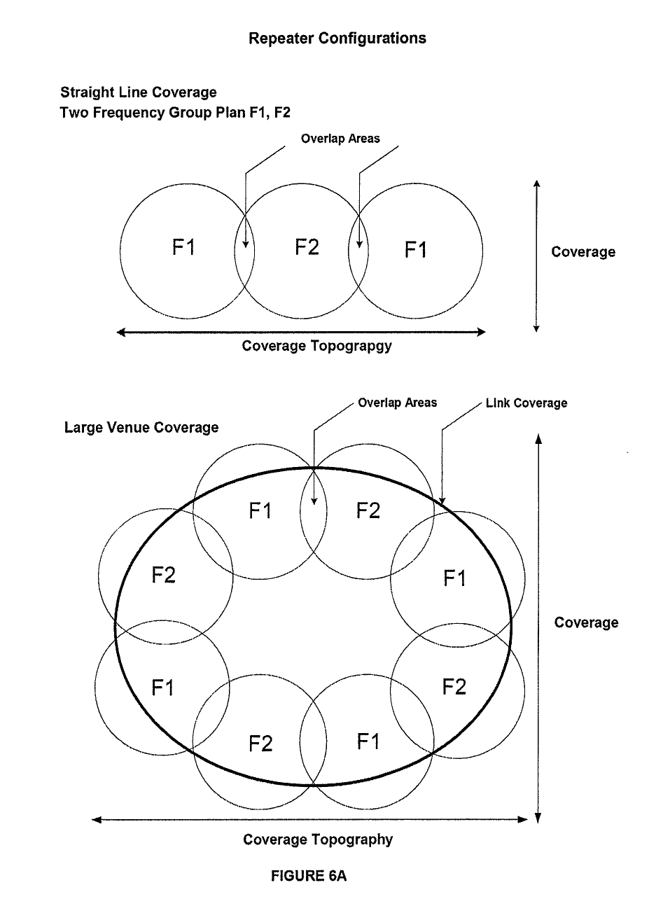

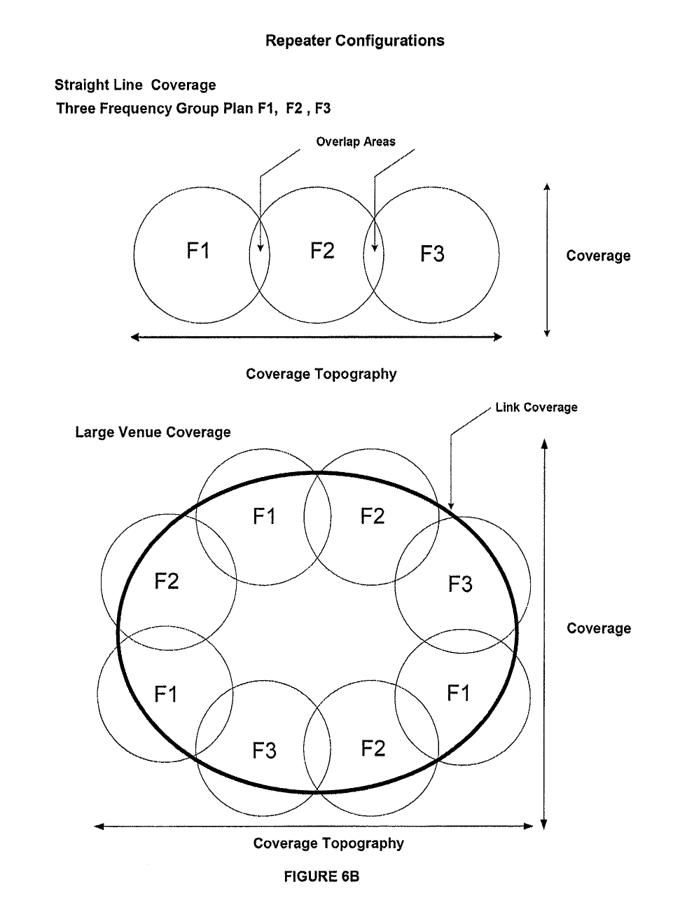

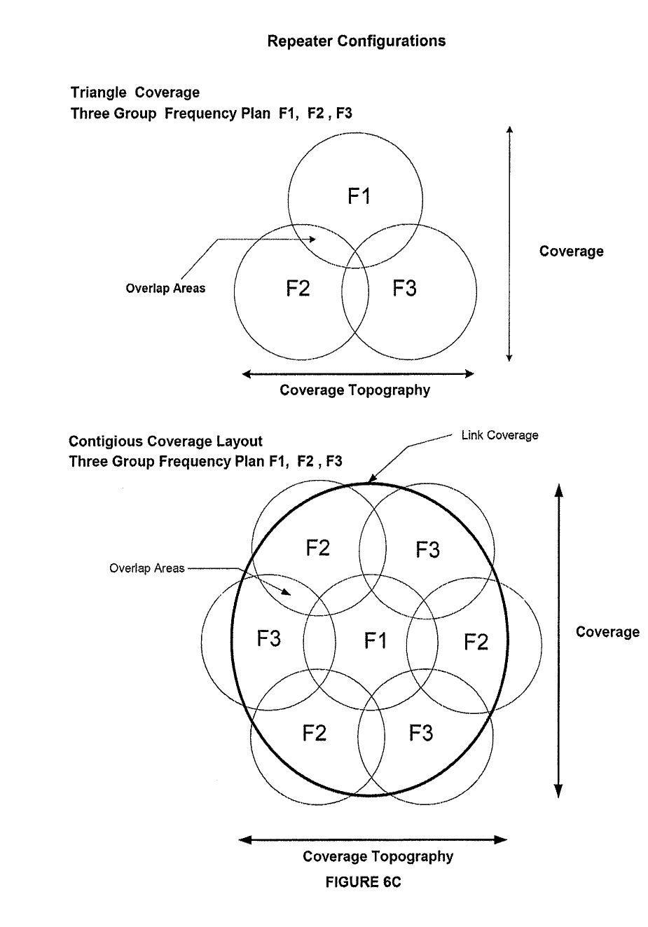

FIGS. 6A, 6B and 6C are pictorial representations of various repeater configurations. In this regard, for example, FIG. 6A shows a configuration in which two transmission frequencies are employed with adjacent transmitters each having different frequencies. FIG. 6B shows a configuration in which three transmission frequencies are employed with each adjacent transmitter employing a sequential different one of the three frequencies to cover a perimeter of a large venue or to provide a straight line configuration. FIG. 6C shows another configuration in which three transmission frequencies are employed. In the embodiment of FIG. 6C two of the three frequencies may be employed in alternating fashion to define coverage for a perimeter region of a large venue while the third different frequency may define coverage for interior portions of the venue.

FIG. 7 relates to a receiver switching algorithm according to an exemplary embodiment. The switching algorithm may be invoked within the billboard receiver's 100 microcontroller when a program preset is selected that is associated with the venue's unlicensed broadcast network. The receiver switching algorithm may automatically resolve what frequency to tune to from a group of pre-determined frequencies that have been assigned to that particular program preset within the receiver. The receiver air interface switching algorithm may be explicitly designed to perform in slow moving mobile environments i.e. a person walking or conceivably running which would be characteristic of an individual attending an indoor or outdoor sporting event. The switching algorithm may be autonomous within the receiver as, according to an exemplary embodiment, the receiver is a receive only device and cannot exchange any control or status information back to the broadcast repeater or network.

The receiver switching algorithm may efficiently utilize the receiver's limited processor resources and may be fully effective in determining and executing a frequency retune of the receiver's radio-chip. Seamless program reception may be maintained throughout the radio-chip's frequency switchover so long as the receiver roams within the confined coverage area being provided by the group of pre-configured repeaters. Since an unlicensed repeater is typically limited to coverage distances of a couple of hundred feet (FM band unlicensed), and the receiver may typically be moving relatively slow (if at all), i.e. the speed of a person walking, it is unlikely that there would be rapidly descending or ascending signal levels being received. Furthermore, sudden and frequent receiver zone changes would not generally occur. Additionally, once the sporting event has started, the spectator, spectator or user would more than likely be stationary within a single coverage zone. Consequently the receiver switching algorithm may not have to continuously interrogate the receiver's onboard radio-chip for instantaneous signal and status values.

Given that the broadcast signal being received is typically not of a digital nature, there is no clock synchronization, error correction or frame recovery to consider when performing a frequency change within the receiver. The algorithm may not be able to utilize metrics such as BER (bit error rate), CRC errors, Sync loss or any other digital parameter associated with a digital serial bit stream. The broadcast signal being received may be strictly analog in makeup whether it is in the AM or FM broadcast bands. Since the identical program may be simultaneously transmitted from the group of appropriately placed repeaters, only audio phase delay would typically have any possible impact on the received audio quality when switching. However, since the repeaters themselves are linked wirelessly via a common RF link, the incurred audio delay to each of the respective repeaters over these relatively short distances would likely be negligible.

Switching algorithms that are strictly based just on received signal strength only tend to initiate too many unnecessary switchovers. A key aspect of the switching algorithm being described herein is that it employs thresholds, comparison values and timer based limits associated with both the radio-chips interrogated RSSI and the transmitted 19 KHz stereo pilot signal. The algorithm threshold values may incorporate hysteresis in order to eliminate any unnecessary toggling between repeater frequencies within the receiver. Processing techniques associated with comparison values, timer based limits and threshold limits assist in implementing query intervals, hold periods, check times, and most importantly the determination of exact frequency switchover points. The conjunction of these processes ensures that there is no dithering within the switching algorithm and that an instantaneous and seamless frequency switchover transpires within the receiver that is virtually inaudible to the listener. Any dithering in the receiver frequency switching algorithm may result in irregular program interruptions during of the frequency switchover period as the broadcast audio program is real-time in nature.

In view of the fact that the venue repeaters may be transmitting a stereo signal, a stereo pilot may be continually transmitted as well. This stereo pilot signal may be utilized by the receiver switching algorithm to ensure that, when an I2C frequency value has been sent to the radio-chip, the receiver has tuned and locked onto a FM stereo repeater signal. The stereo pilot may be demodulated and detected within the single-chip radio and its value is obtainable upon a status query by the microcontroller. The single-chip radio via an I2C status query may indicate a binary zero for the absence of a stereo pilot signal and a binary 1 for the presence of a stereo pilot signal.

The relative signal strength being received by the single-chip radio is denoted by the RSSI value. The RSSI may be a 4 bit binary value representing the current level of received signal that the radio-chip is experiencing at a specific frequency. The current RSSI value may be made available upon an I2C status query from the switching algorithm and ranges from a binary value of 0000 equaling no received signal to 1111 representing maximum received signal strength. The switching algorithm may only process an interrogated RSSI value so long as the stereo pilot signal is simultaneously present by having its defined bit being set to a binary one value. This technique eliminates the possibility of the radio-chip having an RSSI indication due to the presence of high noise or adjacent channel interference and whereby the switching algorithm would misinterpret this reading and cause erroneous channel switching and false tuning of the receiver. The algorithm may operate on a plurality of state variables that may be read in from the single-chip radio. CR (Current RSSI), is the present RSSI value being read from the radio chip, PR (Previous RSSI) was the preceding RSSI value read from the radio chip, PD (Pilot Detect) is the value of the stereo presence signal.

In an exemplary embodiment, the algorithm may include a two bit programmed variable for each of the four preset buttons representative of how many unique repeater frequencies are associated with each program. The programmed variable representing the number of frequencies for each of the preset buttons may be NF1, NF2, NF3, and NF4. For a program button receiving a fixed frequency off-air station the NF value would be set to a binary 1 value. The maximum number of frequencies that can be assigned to any preset may be four. The actual available receiver frequencies for each of the selectable presets are programmed and stored within microcontroller EPROM or RAM. Several global variables associated with the RSSI parameter may be programmed and stored within the microcontroller's non-volatile EPROM. The switching algorithm may continually reference these set RSSI values to perform computational comparison checks against actual RSSI values received from the radio-chip upon interrogation throughout the algorithm.

The algorithm may operate on a multiplicity of dynamic and fixed variables that are read in from the single-chip radio and microcontroller. All active variables that are computed in active memory (RAM) are initially set to zero. Active and global fixed variables are described below. The depicted flowchart substitute's typical operational numeric values for the set variables in order to simplify the understanding of the module processes. The following descriptions are provided in reference to FIG. 7.

CH is a flag bit that indicates to the algorithm whether a control channel was detected and to use the button parameters that have been remotely sent to the receiver and stored within the microcontroller RAM. No detection of the CH flag bit and the algorithm defaults to the parameters stored in non-volatile EPROM. CR (Current RSSI) variable is the present RSSI value being read from radio-chip one.

HR (Handoff RSSI) variable is the present RSSI value being read from radio-chip two.

PR (Previous RSSI) was the preceding RSSI value read from the radio chip, PD (Pilot Detect) is the value of the stereo presence signal.

Global set variable GR (Guaranteed RSSI) is a minimum value representative of a guaranteed and satisfactory RSSI level in which the algorithm may not need to switch to an alternate frequency within the pre-programmed group of frequencies associated with the selected preset. It is associative of the receiver being in close proximity of the repeater it is currently tuned to.

Global set variable AR (Absent RSSI) is a set value corresponding to the absence of a signal on the currently tuned frequency of the radio-chip (zero RSSI value) and is indicative of the receiver being out of range to that particular repeater frequency.

Global set variable MR (Marginal RSSI) is a set range that is less than the GR (Guaranteed RSSI) value but greater than the TH (Threshold RSSI) value and is an indication that the receiver is currently or approaching the fringe area of the repeater it is currently tuned to.

Global set variable SR (Switchable RSSI), is a fixed programmable variable that sets the minimum acceptable value the HR (Handoff RSSI) must be before it may be compared against the CR (Current RSSI) of radio-chip one.

Variable RR (Resolved RSSI) is a value that is greater or equal to that of the Threshold RSSI TR.

Set variable TH (Threshold RSSI) is the minimum RSSI value the receiver can have while still receiving a distinguishable signal with pilot subcarrier and stereo being detected.

PI (Prolonged Interval) is a fixed programmable variable and represents the increased scan time interval value in seconds between radio-chip status interrogations when the CR (Current RSSI) value is equal or greater than the GR (Guaranteed RSSI) value.

RI (Reduced Interval) is a fixed programmable variable and represents the decreased scan time interval value is seconds between radio-chip status interrogations when the CR (Current RSSI) value is in the MR (Marginal RSSI) range value.

AT (Acquisition Time) is a fixed programmable variable for both radio-chips that represents the time it takes to retune the radio-chip to a new frequency and lock up the pilot detector and, MPX decoder and subsequent status parameters.

HV (Hysteresis Value) is fixed programmable variable that represents the amount of improved RSSI required in the Handoff RSSI (HR) value over the Current RSSI (CR) value.

L1 is the loop scan multiplier value for radio-chip one and represents the number of times each individual frequency within a group may be interrogated for a valid RSSI value.

L2 is the loop scan multiplier value for radio-chip two and represents the number of times each individual frequency within a group may be interrogated for a valid RSSI value.

L3 is the loop scan multiplier value for radio-chip two and represents the number of times each individual frequency within a group may be interrogated for a threshold RSSI value.

L4 is the loop scan multiplier value for radio-chip one in preemptive mode and represents the number of times each individual frequency within a group may be interrogated for a valid RSSI value.

S1 (Scan Count I) is the number of frequencies radio-chip one has tuned to in searching for a qualifying RSSI signal.

S2 (Scan Count 2) is the number of frequencies radio-chip two has tuned to in searching for a qualifying RSSI signal.

S3 (Scan Count 3) is the number of frequencies radio-chip two has tuned to in searching for a resolved RSSI signal.

S4 (Scan Count 4) is the number of frequencies radio-chip one has tuned to in searching for a qualifying RSSI signal in preempted mode.

SF (Switch Frequency) is a variable indicating the value of a valid handoff frequency HR acquired by radio-chip two.

Global set variable HT (Hold time) is the maximum continuous time radio-chip one may stay tuned to a frequency that exhibits a MR (Marginal RSSI) value before examining another group frequency in preempted mode.

Variable SC (Scan Count) is the product of the NF value (Number of Group Frequencies) multiplied by the Ln value (Loop Scan Multiplier) and represents the maximum number of allowed frequency re-tunes to be sent to the radio-chip.

SW Bit (Switch Bit) is a bit in memory indicating that the zone receiver (radio-chip 2) has an available and qualifying frequency for the program receiver (radio-chip one) to switch to.

NF (Number of Frequencies) is a variable indicating the number of frequencies utilized and associated with the preset program button.

The flowchart in FIGS. 7A, 7B, 7C and 7D depicts by way of illustrative representation the receiver's operation and tuning algorithm. The flowchart illustrates the sequences and processes that accomplish the distinctive tuning and aural announcement capabilities of the receiver. The flowchart diagrams represent general program sequences and does not represent any actual or hardware specific commands that someone familiar in the art could identify with. The flowchart does illustrate processing times; interrupt priorities, logic functions and computational processes in a systematic fashion that reflect the operation of the receiver's firmware. These processes could be flowcharted in a different manner or progression by those who are familiar in the art that results in the same outcome by combining processes and or using alternative hardware. Although in the preferred embodiment of the flowchart describes the receiver operating in the FM broadcast band for the group frequency operation, it can also be programmed separately or simultaneously to function with AM broadcast frequencies by changing some of global and fixed variables and pilot detection functions.

Upon initial powering up of the receiver the microcontroller and peripheral electronics are taken out of a low power consumption sleep mode. Subsequently the receiver's microcontroller initializes a greeting audio advertisement by selecting an address from the audio PROM which is switched and played out to the audio headphones. This initial audio advertisement is approximately 10 seconds in duration and provides a sufficient amount of time for the receiver to scan and find a control channel for the reception and demodulation of receiver parameters associated with the particular venue.

While the audio advertisement is being played, the microcontroller may issue I2C commands that are sent to the program receiver (radio-chip one) to start sequentially scanning from the highest to the lowest broadcast frequency on either the AM or FM broadcast bands. Furthermore the receiver's baseband output is switched into an audio phase lock-loop tone decoder circuit which may detect and decode the existence of an AFSK audio frequency shift keying tone identifying that it has found the control channel frequency. Upon the detection of the AFSK tones the microcontroller ceases to send any further I2C commands and the receiver and remains tuned to the control channel frequency.

If the control channel exists and is detected, the receiver may remain tuned to the control frequency for the duration of the aural advertisement and forward the demodulated AFSK binary data to the microcontroller where it is asynchronously decoded and checked for errors. The microcontroller firmware may also set a Control Channel Present indicator bit to specify that the switching algorithm use the parameters that have been remotely sent to the receiver over the control channel. These parameters are stored within a designated area of RAM within the microcontroller for the switching algorithm to access.

The control channel continually broadcasts all parameters associated with the venue's broadcast network and off air broadcast stations corresponding to each of receiver's preset buttons. This information consists of data relating to each of the receivers preset buttons which include the assigned button number, the associated frequency or group frequencies, the band of operation AM or FM, the advertisement prompt addresses, stereo MPX decoder on/off and the baseband output switch configuration. The control channel repetitively sends a block of associated data for each of the preset buttons. The data is decoded by the microcontroller on a per block basis and checked for errors via a checksum or FEC process. As each valid block is attained the microcontroller stores the decoded data into the designated area of RAM within the microcontroller. If a data block is corrupted, it may be received again as the broadcast control channel sequentially and repeatedly sends the pre-set button information. If the control channel is not detected the microcontrollers firmware may set the Control Channel Bit to a binary zero to indicate to the switching algorithm to use the preset button parameters that have been pre-programmed in microcontroller EPROM. Once the initial audio advertisement has completed its play out, the button I/O lines are enabled allowing the user to select a program of choice.

The receiver via pre-set frequencies (stored in EPROM) or remotely programmed (stored in RAM) is able to directly tune to a fixed AM or FM designated broadcast frequency. The fixed frequency broadcast can originate from a high power off air broadcast station or a low power single license-free or multi-transmitter simulcast system. The processes involved are shown in FIG. 7A are described in relation to various modules (indicated with circled values corresponding to each process operation) 1, 2, 3, 4, 5, 6, 7, 8, 9, 10, 11, 12, 13, 14, 15, 16, 17, 18, and 19 and are described below. In this regard, each value in parenthesis below corresponds to a respective one of the modules.

(1) After the receiver greeting prompt is played, the receiver awaits for the depression of one of the preset program buttons B1, B2, B3 or B4.

(2) The selection of one of the program buttons causes one of four associated I/O lines to go low interrupting the microcontroller.

(3) The microcontroller firmware decodes the I/O interrupt and determines which one of the pre-set program buttons was depressed by the user. The microcontroller subsequently disables any further button I/O interrupts from the pre-set program buttons.

(4) The firmware retrieves from either the microcontroller's RAM (receiver was remotely programmed) or EPROM (receiver was pre-programmed) the button's associated voice start PROM address.

(5) The corresponding advertisement PROM start address is read in and sent across the parallel address bus of the audio PROM.

(6) The firmware sets the baseband switching to provide an audio path from the Audio PROM output through the digital attenuator, the audio amplifier and into the user headphones.

(7) The microcontroller sends a high enable signal to the audio PROM which starts the audio advertisement play out from the gated PROM starting address.

(8) The firmware reads the number of unique frequencies associated with the selected program button from either the microcontroller's RAM or EPROM.

(9) The number of frequencies value is fetched and is to be used in module 10 as the NF value.

(10) If the NF value (Number of associated frequencies) is equal to one the firmware may advance to module 11. If the NF value is greater than or equal to two, the firmware may proceed to module 20.

(11) The NF value has been determined to be equal to one and the firmware may retrieve the single fixed frequency value associated with the depressed program button from either the microcontrollers RAM or EPROM.

(12) The stored fixed frequency value residing in RAM or EPROM can be any standard frequency residing in the AM or FM broadcast band.

(13) The microcontroller issues a sequence of I2C commands containing various radio-chip parameters to the program receiver (Receiver #1). These include band of operation, required de-emphasis, IF bandwidth, LNA gain, AGC speed, and most importantly the frequency that was fetched from memory in module 11.

(14) The firmware retrieves from RAM or EPROM the baseband switch configuration data associated with the assigned preset button.

(15) The stored baseband switch data residing in RAM or EPROM can switch to an alternate program via the user preset buttons through a baseband switch instead of a frequency switch in the FM band of operation.

(16) The microcontroller firmware waits for an I/O interrupt associated with the audio PROM indicating that the selected button audio advertisement has completed its play out.

(17) The firmware sends via an I2C command the baseband switch value from module 14 to the bandband switch enabling the tuned receiver's audio to be passed onto the headphones.

(18) The firmware re-enables the I/O interrupt lines on pre-set buttons B1, B2, B3, and B4 allowing the user now to select another program if they desire.

(19) The microcontroller monitors for an interrupt request on all four I/O interrupt lines associated with buttons B1, B2, B3, and B4 which may signify to the firmware that the user has depressed a program preset button.

The receiver has the capability to receive low power or license-free broadcast band signals by intelligently switching between a group of pre-assigned and known repeater frequencies that are stored either within the microcontroller's EPROM or RAM. This switching mode provides non-preemptive switching by utilizing two radio-chips within the receiver for the switching algorithm. The processes involved are shown in FIG. 7A, 7B and 7C modules 1, 2, 3, 4, 5, 6, 7, 8, 9, 10, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51. 52, 53, 54, 55, 56, 57, 58, 59, 60, 61, 62, 63, 64, 65, 66, 67, 68, 69, 70, 71, 72, 73, 74, and 75 are explained below.

(1) After the receiver greeting prompt is played the receiver is awaits for the depression of one of the preset program buttons B1, B2, B3 or B4.

(2) The selection of one of the program buttons causes one of four associated I/O lines to go low interrupting the microcontroller.

(3) The microcontroller firmware decodes the I/O interrupt and determines which one of the program buttons was depressed by the user. The microcontroller subsequently turns off and disables any further button I/O interrupts from the program buttons in module 2.

(4) The firmware retrieves from either the microcontroller's RAM (receiver was remotely programmed) or EPROM (receiver was pre-programmed) the associated button voice PROM address.

(5) The corresponding advertisement PROM start address is read in and sent across the address bus of the audio PROM.

(6) The firmware sets the baseband switching to provide an audio path from the Audio PROM output through the digital attenuator, the audio amplifier and into the user headphones.

(7) The microcontroller sends a high enable signal to the audio PROM which starts the audio advertisement play out from the gated PROM starting address.

(8) The firmware reads the number of unique frequencies associated with the selected program button from either the microcontroller's RAM or EPROM.

(9) The number of frequencies value is fetched and is to be used in module 10 as the NF value.

(10) If the NF value (Number of associated frequencies) is greater than or equal to two the firmware advances to module 20.

(20) The firmware polls specific addresses over the I2C bus to determine the number of radios that are equipped within the receiver. If the number of equipped radios is equal to two the firmware proceeds to module 21.

(21) The firmware retrieves the first frequency from the group frequency list that is stored either in RAM or EPROM which is associated with the depressed program button. These stored group frequency values residing in memory are pre-determined known frequencies that have been assigned and deployed within the local region or venue.

(22) The microcontroller issues a sequence of I2C commands containing various radio-chip parameters to the program both radio-chips (receiver #1 and receiver #2). These include band of operation, required de-emphasis, IF bandwidth, LNA gain, AGC speed, and most importantly the first frequency that was fetched from memory in module 21.

(23) The firmware retrieves from RAM or EPROM the baseband switch configuration data associated with the assigned preset button.

(24) The stored baseband switch data residing in RAM or EPROM can switch to an alternate program via the user preset buttons through a baseband switch instead of a frequency switch in the FM band of operation.

(25) The microcontroller firmware waits for an I/O interrupt associated with the audio PROM indicating that the associated audio advertisement has completed its play out.

(26) The firmware sends via an I2C command the baseband switch value from module 23 to the bandband switch enabling the tuned program receiver's audio to be passed onto the headphones.

(27) The firmware re-enables the I/O interrupt lines on pre-set program buttons B1, B2, B3, and B4 allowing the user to select another program if they desire. During the audio advertisement the firmware does not allow a new program selection of the receiver by the user.

(28) The firmware waits 50 msec for radio-chip tuning acquisition time, stereo pilot detection, MPX decoder PLL lock and valid status information. The time 50 msec represents the global variable AT (Acquisition Time) and is a programmed variable in that resides in EPROM and is the same for both radio-chips if equipped.

(29) The microcontroller interrogates radio-chip one through I2C commands for the presence of FM subcarrier pilot and an RSSI value. The interrogated RSSI value is only valid if a corresponding stereo subcarrier bit is detected indicating the reception of a stereo signal. A valid RSSI value is represented as the Current RSSI or CR value. If the current RSSI is less than one (The Absent RSSI or AR fixed state variable value) and no subcarrier pilot is detected the firmware advances to module 30.

(30) The firmware checks a designated memory location in RAM for the presence of a valid Switch Frequency SF that was resolved by radio-chip two to have a better RSSI than that of receiver one. If there is no valid Switch Frequency SF value the firmware advances to module 31. Radio-chip one must acquire a frequency with a suitable RSSI value first before radio-chip two can search for a qualifying Switch Frequency SF.

(31) The firmware retrieves from memory the next (incremented) frequency from the group frequency list that is stored either in RAM or EPROM which is associated with the depressed program button.

(32) The microcontroller subsequently sends the new (next) frequency value assignment to tune receiver one via the I2C bus.

(33) The firmware increments variable S1 that counts the number of times the radio-chip one has changed its tuned frequency.

(34) The firmware checks if the value of variable S1 is greater than the number of frequencies value (NF) multiplied by L1 the loop scan count value. The value of L1 represents the number of times each individual frequency within the frequency group may be checked for a valid RSSI value. If the variable S1 is not greater than value NF multiplied by L1 the firmware reverts to module 28.

(28) As a result of the new frequency assignment in module 31, the firmware waits 50 msec for radio-chip tuning acquisition time, stereo pilot detection, MPX decoder PLL lock and valid status information. The 50 msec time is represented by the global variable AT (Acquisition Time) and is a programmed variable in that resides in EPROM. The radio firmware stays in a continuous loop of modules 28, 29, 30, 31, 32, 33, 34, until either a valid RSSI value is attained in module 29 indicating that the receiver has found a suitable signal or the value of S1 has exceeded the scan count.

(35) If the value of S1 has exceeded the scan count indicating S1 is greater than the number of frequencies multiplied by the scan count L1, variables S1 and S2 are reset to a value of zero and the firmware progresses to module 36.

(36) The firmware sets the baseband switching to provide an audio path from the Audio PROM output through the digital attenuator, the audio amplifier and into the user headphones.

(37) The firmware retrieves from the microcontroller's EPROM the starting voice PROM address associated with the canned message indicating that the user is out of the geographic area for the reception of their program selection.

(38) The firmware enables the voice PROM to play the out of area audio message through the digital attenuator, audio amplifier and subsequently to the user headphones. The firmware advances to module 19.

(19) The microcontroller monitors for an interrupt request on all four I/O interrupt lines associated with buttons B1, B2, B3, and B4 which may signify to the firmware that the user has depressed a new program preset button. The program radio-chip one must find a suitable signal before radio-chip two is allowed to search for an improved handoff frequency.

(29) The microcontroller interrogates radio-chip one via I2C commands for the CR Current RSSI value. IF the CR value is determined to be greater than or equal to the Guaranteed Signal (GS) level value, the firmware advances to module 41. The GS value is a fixed variable that is set within the microcontroller EPROM.

(41) When radio-chip one is receiving a guaranteed signal level value, its indicative of the receiver being in close proximity and in the coverage zone of the associated transmitter broadcasting on frequency fn. The firmware operates with a prolonged Scan Interval PI value by waiting 1 second. The PI value is a fixed variable that is set with the microcontroller EPROM. The reduced scan internal also conserves the receiver's battery life as the microcontroller is performing minimal processing for a period of 1 second.

(42) The firmware checks to make sure that the group frequency that radio-chip two is tuned to is not equal to the group frequency that radio-chip one is tuned to. If the frequencies are equal, module 43 is executed next.

(43) The frequency of radio-chip one is equal to that of radio-chip 2, and the next frequency associated with the button frequency group is retrieved from either RAM or EPROM.

(44) The firmware checks to make sure that the group frequency that radio-chip two is tuned to is not equal to the group frequency that radio-chip one is tuned to. If the frequencies are equal, module 43 is executed next. If the frequency of radio-chip one does not equal the frequency of radio-chip two module 45 is subsequently processed.

(45) The microcontroller issues a sequence of I2C commands containing various radio-chip parameters to the zone receiver (Receiver #2). These include band of operation, required de-emphasis, IF bandwidth, LNA gain, AGC speed, and most importantly the frequency that was determined in module 44.

(46) As a result of the frequency assignment in module 43, the firmware waits 50 msec for radio-chip tuning acquisition time, stereo pilot detection, MPX decoder PLL lock and valid status information, The 50 msec time is represented by the global variable AT (Acquisition Time) and is a fixed programmed variable in that resides in EPROM. Module 47 is executed next.

(47) The microcontroller interrogates radio-chip two through I2C commands for the presence of FM subcarrier pilot and an RSSI value. The interrogated radio-chip 2 RSSI value is only valid if a corresponding stereo subcarrier bit is detected indicating the reception of a stereo pilot signal. A valid RSSI value is represented as the Current Handoff RSS1 or HR value. If the current Handoff RSSI is greater than or equal to that of the Switch-able RSSI value SR the firmware proceeds to module 50. If the HR value is less than the SR value the firmware executes module 48. The SR Switch-able RSSI value is a fixed programmed variable that resides in the microcontrollers EPROM.

(48) The firmware increments variable S2 that counts the number of times the radio-chip two has changed its tuned frequency.

(49) The firmware checks if the value of variable S2 is greater than the number of frequencies value (NF), multiplied by L2 the loop scan count value. The value of L2 represents the number of times each individual frequency within the frequency group may be checked for a valid Handoff RSSI HR value. If the variable S2 scan count is not greater than the NF value times the L2 scan multiplier value the firmware reverts back to module 43 where the next group frequency is retrieved from memory. The process in modules 43, 44, 45, 46, 47, 48, and 49 repeat until either a switch-able RSSI value SR is obtained or the scan count S2 is exceeded. If a switch-able RSSI value is acquired the firmware implements module 50.

(50) The Firmware determines if the Handoff RSSI value HR is greater than the Current RSSI value CR plus the hysteresis value HV. The hysteresis value HV, is a fixed program variable stored in the microcontroller EPROM which is representative of the amount of improved RSSI required in the Handoff RSSI value over the Current RSSI value. This ensures that the subsequent processing modules may enable a handoff frequency to radio-chip one that provides an improved RSSI signal than that of the current frequency it is tuned to. This measure also provides a degree of hysteresis whereby there is a sufficient difference in the CR and HR values to prevent any toggling of the program receiver radio-chip one. If the HR value is less than the CR plus the HV value the firmware returns to module 48 again where it increments the scan count S2. If the HR value is greater than the CR plus the HV value the firmware proceeds to module 51.

(51) The current frequency of radio-chip two is saved to a reserved location in RAM as the Switch Frequency SF. Additionally a SW bit is set to a one in RAM to signify a later module 53 that there is an available and improved frequency for radio-chip one to tune to. The firmware continues to module 52.

(52) Upon either a Saved Frequency SF being stored or the Scan Count S2 being exceeded the values of Scan count S1 and Scan count S2 are reset to zero. The subsequent module 53 is performed.

(53) The SW bit is examined in memory for a one or zero binary value. If the SW bit is equal to a zero indicates that there is no improved group frequency available for radio-chip one to switch to and modules 29, 41, 42, 43, 44, 45, 46, 47, 48, 49, 50, 51, and 52 are executed accordingly. If the SW bit in memory is equal to a binary one the firmware advances to module 30.

(30) The firmware examines the memory location for a valid and saved Switch Frequency SF that was determined from module 51. If the Switch Frequency value is present the firmware continues to module 54.

(54) The firmware subsequently sends via the I2C bus the Switch frequency SF value that was examined in module 30 to radio-chip one. The algorithm proceeds to module 55.

(55) The firmware resets the SW bit to a binary zero value in memory and continues to module 56.

(56) The firmware in addition clears the last Switch Frequency value from memory and proceeds back to module 28.

(28) The firmware waits 50 msec for radio-chip tuning acquisition time, stereo pilot detection, MPX decoder PLL- lock and valid status information. The time 50 msec represents the global variable AT (Acquisition Time) and is a programmed variable in that resides in EPROM. Radio-chip one is now tuned to the new frequency assignment SF which was evaluated to have an improved RSSI value over the previously tuned frequency and proceeds to module 29.

(29) The microcontroller interrogates radio-chip one via I2C commands for the CR Current RSSI value. IF the CR value is determined to have a marginal value MR which is a value greater than the Absent RSSI AR but less than the Guaranteed Signal level GS the firmware advances to module 39.

(39) When radio-chip one is receiving a marginal signal level value MR, it's indicative of the receiver being in a low signal fringe area. The firmware operates with a Reduced Scan Interval RI value by waiting only 0.5 seconds instead of the 1 second as in module 41. The RI value is a fixed variable that is set within the microcontroller EPROM, The Reduced Scan Interval RI allows for a higher sampling rate under poorer signal conditions of the Current RSSI CR value. It also decreases the time period for the second radio-chip to start analyzing if an alternate improved RSSI frequency is available. The subsequent module 40 is processed.

(40) Module 40 acts as a damping loop as the firmware re-samples the Current RSSI CR value and re-qualifies its value in case the previous RSSI value in module 29 was subject to any erroneous or instantaneous signal fluctuations. If the re-sampled Current RSSI CR drops so that of the Absent RSSI AR value the firmware immediately proceeds to modules 30, 31, 32, 33, 34, 28 in search of a new group frequency for radio-chip one with a suitable RSSI signal. If the re-sampled Current RSSI CR increases to the where the value is determined to be greater than or equal to the Guaranteed Signal (GS) level value, the firmware proceeds to modules 42, 43, 44, 45, 46, 47, 48, 49, 50, 51, and 52 where radio-chip two examines the remaining group frequencies for a valid Switch Frequency SF. If the re-sampled Current RSSI CR value remains as a marginal value MR the firmware progresses to module 57 where the remaining group frequencies are analyzed for the best possible Switch Frequency SF.

(57) The firmware increments variable S3 that counts the number of times the radio-chip two has changed its tuned frequency. The firmware proceeds to module 58.

(58) The firmware interrogates radio-chip two through I2C commands for the presence of FM subcarrier pilot and an RSSI value. A valid RSSI value status reading is represented as the Resolved RSSI RR which is greater than or equal to that of the Threshold RSSI TR. Both the Resolved and Threshold RSSI values are fixed program variables that are programmed in the microcontroller EPROM. If the RR value is greater than or equal to the TR value the firmware proceeds to module 59. If the RR value is less than the Absent RSSI or AR value (no signal present) the firmware advances to module 61.

(61) The firmware retrieves the next (incremented) frequency from the group frequency list that is stored either in RAM of EPROM which is associated with the depressed program button. The retrieved frequency is attainted through a revolving pointer that selects the next group frequency.

(62) The firmware checks to make sure that the group frequency that has been selected for radio-chip two is not equal to the group frequency that radio-chip one is tuned to. If the frequencies are equal, module 61 is executed next. If the frequency of radio-chip one does not equal the selected frequency for radio-chip two module 63 is subsequently processed.

(63) The firmware checks if the value of variable S3 is greater than the number of frequencies value (NF), times by L3 the loop multiplier value. The value of L3 represents the number of times each individual frequency within the frequency group may be checked for a valid Resolved RSSI RR value. If the variable S3 scan count is not greater than the NF value times the L3 scan multiplier value the firmware proceeds to module 64. If the variable S3 scan count is exceeded the firmware proceeds to module 66.

(64) The microcontroller issues a sequence of I2C commands containing various radio-chip parameters to the zone receiver (Receiver #2). These include band of operation, required de-emphasis, IF bandwidth, LNA gain, AGC speed, and most importantly the next group frequency that was determined in module 61. The firmware continues to module 65.

(65) The firmware waits 50 msec for radio-chip two's tuning acquisition time, stereo pilot detection, MPX decoder PLL lock and valid status information. The time 50 msec represents the global variable AT (Acquisition Time) and is a programmed variable in that resides in EPROM and is the same value for both radio-chips if equipped. The firmware proceeds with modules 57, 58, 61, 62, 63, 64, and 65 in searching for an RSSI that is equal or greater than the Threshold RSSI TR where subsequently module 59 is executed.

(59) The firmware stores in a known and reserved memory (RAM) location both the Resolved RSSI value RR and its associated frequency. The firmware proceeds with modules 60, 61, 62, 63, 64, 65, 57, 58, and 59 again until the 53 scan count is exceeded an all the qualified Resolved RSSI RR and frequency values are stored in a sequential memory location. Module 60 handles the storing of the RSSI and associated frequency values and their memory placement.

(66) Upon the value of S3 the scan count being exceeded in module 63 the firmware reset the S3 scan count to a binary zero value and proceeds to module 67.

(67) The firmware examines the memory locations of module 60 for the presence of Resolved RSSI values RR and their associated frequencies. If no values are present radio-chip one is not assigned a new Switch Frequency SF and the firmware proceeds back to modules 53 and 29 where radio-chip one's CR value is reexamined. If the memory locations in module 60 contain Resolved RSSI values and associated frequencies the firmware progresses to module 68.

(68) Firmware in module 68 fetches from the stored memory locations of module 60 all Resolved RSSI RR values and associated frequencies and continues on to module 69.

(69) The firmware processes the fetched RR values and determines if a single or highest RR value exists from the retrieved memory values in module 68 and passes these highest RR values and there corresponding frequencies onto module 70.

(70) Module 70 determines if only a single highest Resolved RSSI RR value present or if two or more values of equal RR values are detected. If only one highest RR is detected the firmware continues onto module 72. If multiple highest values of RR are detected (two or more values that have the highest but equal RR values) the firmware proceeds to module 71.

(71) Module 71 reads in the associated frequencies from module 70 that have the highest but equal RR values. The firmware may compute and select the Resolved RSSI RR with the lowest associated frequency amongst the RR values of equal value. This procedure of selecting the lowest frequency may aid in reducing any toggling of the Switch Frequency SF that is made available to radio-chip one. Module 72 is subsequently processed.

(72) The process in module 72 receives either the single largest available Resolved RSSI RR value from module 70 or the frequency calculated RR value from module 71. This RR value is compared to the Current RSSI CR value of radio-chip one. If the Resolved RSSI RR value is greater than the CR value plus the HV value the firmware advances to module 73. If the Resolved RSSI RR value is less than or equal to the CR value plus the HV value the firmware proceeds back to module 53 and 29 where radio-chip one's CR value is reexamined.

(73) The firmware in module 73 saves the associated group frequency which correlates to the improved RR value that was greater than the CR value plus the HV value and saves this frequency as the next Switch Frequency SF value. Module 74 is subsequently processed.

(74) The firmware sets the SW bit flag equal to a binary one value indicating to radio-chip one that there is an improved frequency available for switching to. Module 75 is processed next.

(75) This module clears the all frequency and RSSI data that was stored in reserved memory locations by modules 59 and 60. The firmware advances through modules 53, 30, 54, 55, 56, and 28 and retunes radio-chip one to the newly assigned and improved group frequency.

The receiver has the capability to receive low power or license-free broadcast band signals by intelligently switching between a group of pre-assigned and known repeater frequencies that are stored either within the microcontroller's EPROM or RAM. This second switching mode provides preemptive switching by utilizing a single radio-chip within the receiver for the switching algorithm. The algorithm provides optimal switching if the NF value is two as the receiver by default only has one alternative frequency to interrogate before switching back to its original frequency. If the NF value is greater than two the algorithm provides virtually hitless switching that is possibly noticeable to the user.

The processes involved are shown in FIG. 7A and 7D modules 1, 2, 3, 4, 5, 6, 7, 8, 9, 10, 20, 76, 77, 78, 79, 80, 81, 82, 83, 84, 85, 86, 87, 88, 89, 90, 91, 92, 93, 94, 95, 96, 97, 98, 99, 100, 101, 102, and 103 are explained below.

(1) After the receiver greeting prompt is played, the receiver is awaits for the depression of one of the preset program buttons B1, B2, B3 or B4.

(2) The selection of one of the program buttons causes one of four associated I/O lines to go low interrupting the microcontroller.

(3) The microcontroller firmware decodes the I/O interrupt and determines which one of the pre-set program buttons was depressed by the user. The microcontroller subsequently disables any further button I/O interrupts from the pre-set program buttons.

(4) The firmware retrieves from either the microcontroller's RAM (receiver was remotely programmed) or EPROM (receiver was pre-programmed) the button's associated voice start PROM address.

(5) The corresponding advertisement PROM start address is read in and sent across the parallel address bus of the audio PROM.

(6) The firmware sets the baseband switching to provide an audio path from the Audio PROM output through the digital attenuator, the audio amplifier and into the user headphones.

(7) The microcontroller sends a high enable signal to the audio PROM which starts the audio advertisement play out from the gated PROM starting address.

(8) The firmware reads the number of unique frequencies associated with the selected program button from either the microcontroller's RAM or EPROM.

(9) The number of frequencies values is fetched and is to be used in module 10 as the NF value.

(10) If the NF value (Number of associated frequencies) is equal to one the firmware may advance to module 11. If the NF value is greater than or equal to two, the firmware may proceed to module 20.

(20) The firmware polls specific addresses over the I2C bus to determine the number of radios that are equipped within the receiver. If the number of equipped radios is equal to one the firmware proceeds to module 76.

(76) The firmware retrieves the first frequency from the group frequency list that is stored either in RAM or EPROM which is associated with the depressed program button.

(77) The stored group frequency values residing in RAM or EPROM are pre-determined known frequencies that have been assigned and deployed within the local region or venue. The firmware proceeds to module 78.

(78) The microcontroller issues a sequence of I2C commands containing various radio-chip parameters to the program receiver (Receiver #1). These include band of operation, required de-emphasis, IF bandwidth, LNA gain, AGC speed, and most importantly the frequency that was fetched from memory in module 76.

(79) The firmware retrieves from RAM or EPROM the baseband switch configuration data associated with the assigned preset button.

(80) The stored baseband switch data residing in RAM or EPROM can switch to an alternate program via the user preset buttons through a baseband switch instead of a frequency switch in the FM band of operation.

(81) The microcontroller firmware waits for an I/O interrupt associated with the audio PROM indicating that the associated audio advertisement has completed its play out.

(82) The firmware sends via an I2C command the baseband switch value from module 79 to the bandband switch enabling the tuned program receiver's audio to be passed onto the headphones. Module 83 is subsequently processed.

(83) The firmware re-enables the I/O interrupt lines on pre-set program buttons B1, B2, B3, and B4 allowing the user to select another program if they desire. During the audio advertisement the firmware does not allow a new program selection of the receiver by the user. Module 84 is executed next.

(84) As a result of the frequency assignment, the firmware waits 50 msec for radio-chip tuning acquisition time, stereo pilot detection, MPX decoder PLL lock and valid status information. The 50 msec time is represented by the global variable AT (Acquisition Time) and is a fixed programmed variable in that resides in EPROM, Module 85 is processed next.

(85) The microcontroller interrogates radio-chip one through I2C commands for the presence of FM subcarrier pilot and an RSSI value. The interrogated RSSI value is only valid if a corresponding stereo subcarrier bit is detected indicating the reception of a stereo signal. A valid RSSI value is represented as the Current RSSI or CR value. If the Current RSSI CR value is less than one (equal to the Absent RSSI AR value) and no subcarrier pilot is detected the firmware advances to module 86.

(86) The firmware retrieves from memory the next (incremented) frequency from the group frequency list that is stored either in RAM or EPROM which is associated with the depressed program button and proceeds to module 87.

(87) The microcontroller subsequently sends the new (next) frequency value assignment to tune receiver one via the I2C bus and advances to module 88.

(88) The firmware increments variable S4 that counts the number of times the radio-chip two has changed its tuned frequency.

(89) The firmware checks if the value of variable S4 is greater than the number of frequencies value (NF) times L4 the loop scan multiplier value. The value of L4 represents the number of times each individual frequency within the frequency group may be checked for a valid RSSI value. If the variable S4 is not greater than value NF multiplied by L4 the firmware goes back to module 84. If the variable S4 is greater than the NF value multiplied by the value of L4 indicates that the receiver is outside of the intended coverage region and did not discover any of the associated group frequencies with a valid RSSI signal. The subsequent module is processed.

(90) The firmware sets the baseband switching to provide an audio path from the Audio PROM output through the digital attenuator, the audio amplifier and into the user headphones.

(91) The firmware retrieves from the microcontroller's EPROM the starting voice PROM address associated with the canned message indicating that the user is out of the geographic area for the reception of their program selection.

(92) The firmware enables the voice PROM to play the out of area audio message through the digital attenuator, audio amplifier and subsequently to the user headphones. The firmware advances to module 19.

(19) The microcontroller monitors for an interrupt request on all four I/O interrupt lines associated with buttons B1, B2, B3, and B4 which may signify to the firmware that the user has depressed a new program preset button.

(84) As a result of the frequency assignment, the firmware waits 50 msec for radio-chip tuning acquisition time, stereo pilot detection, MPX decoder PLL lock and valid status information. The 50 msec time is represented by the global variable AT (Acquisition Time) and is a fixed programmed variable in that resides in EPROM. Module 85 is processed next.

(85) The microcontroller interrogates radio-chip one via I2C commands for the CR Current RSSI value. IF the CR value is determined to be greater than the Guaranteed Signal (GS) level value, the firmware advances to module 93. The GS value is a fixed variable that is set within the microcontroller EPROM.

(93) When radio-chip one is receiving a guaranteed signal level value, its indicative of the receiver being in close proximity and in the coverage zone of the associated transmitter broadcasting on frequency fn. The firmware operates with a prolonged Scan Interval PI value by waiting one second. The PI value is a fixed variable that is set with the microcontroller EPROM. The reduced scan internal also conserves the receiver's battery life as the microcontroller is performing minimal processing for a period of one second. The firmware proceeds to module 94.

(94) The firmware resets the scan count variable S4 to a binary zero value and proceeds back to module 85. As long as the interrogated CR value remains greater than the GS value the receiver stays tuned to the current group frequency and is interrogated with a prolonged scan interval PI of one second.

(85) The microcontroller interrogates radio-chip one via I2C commands for the CR Current RSSI value. IF the CR value is determined to have a marginal value MR which is a value greater than the Absent RSSI AR but less than the Guaranteed Signal level GS the firmware advances to module 95.

(95) When radio-chip one is receiving a marginal signal level value MR, it's indicative of the receiver being in a low signal fringe area. The firmware operates with a Reduced Scan Interval RI value by waiting only 0.5 seconds instead of the 1 second as in module 93. The RI value is a fixed variable that is set within the microcontroller EPROM. The Reduced Scan Interval RI allows for a higher sampling rate under poorer signal conditions of the Current RSSI CR value. It also decreases the time period for the radio-chip to re-scan an alternate group frequency for an acceptable CR value. The subsequent module 96 is processed.

(96) Module 96 acts as a damping loop as the firmware re-samples the Current RSSI CR value and re-qualifies its value in case the previous RSSI value in module 85 was subject to any erroneous or instantaneous signal fluctuations. If the re-sampled Current RSSI CR drops to that of the Absent RSSI AR value the firmware immediately proceeds to modules 86, 87, 88, 89, 84 and 85 in search of a new group frequency with a suitable RSSI signal. If the re-sampled Current RSSI CR increases to the where the value is determined to be greater than or equal to the Guaranteed Signal (GS) level value, the firmware proceeds to back to modules 93, 94 and 85 where radio-chip CR value is re-examined again. If the Current RSSI CR value remains as a marginal value MR the firmware progresses to module 97.

(97) The hold time counter value is set to a zero second count in RAM and the firmware proceeds to module (98).

(98) Module 98 re-samples the Current RSSI CR value and re-qualifies its value in case previous RSSI value in module 96 was subject to any erroneous or instantaneous signal fluctuations. If the re-sampled Current RSSI CR drops to that of the Absent RSSI AR value the firmware immediately proceeds to modules 86, 87, 88, 89, 84 and 85 in search of a new group frequency with a suitable RSSI signal. If the re-sampled Current RSSI CR increases to the where the value is determined to be greater than the Guaranteed Signal (GS) level value, the firmware proceeds to module 99 where the scan count S4 is reset to a binary value zero and subsequently processes modules 95, 96 and 97 again where radio-chip CR value is re-examined again with a reduced RI value of 0.5 seconds. If the Current RSSI CR value remains as a marginal value MR the firmware progresses to module 100.

(100) Firmware in module 100 examines the Hold Time (HT) counter value for exceeding the maximum time the receiver may remain tuned to a group frequency that continually exhibits a Marginal RSSI (MR) value. If the count equals the HT value the firmware proceeds to modules 86, 87, 88, 89, 84 and 85 to re-qualify another group frequency with an improved CR value. If the HT counter does not equal the maximum hold time the firmware continues onto module 101.

(101) The firmware in module 101 waits for a value equal to the RI of 0.5 seconds before it may re-examine the CR value again. Module 102 in processed next.

(102) The Hold Time (HT) counter value H is incremented is incremented by one in memory and the subsequently process the next module.

(103) The Scan Count variable S4 is reset to a binary value of zero.

(98) The firmware interrogates radio-chip one again for a CR value. If it remains as a marginal value, modules 100, 101, 102, 103, and 98 are executed again until the Hold count is reached. If the CR value has improved to the GR value module 99 resets scan count S4 to a zero and proceeds to module 95, and 96. If the CR falls to the AR value it proceeds with another frequency search through to modules 86, 87, 88, 89, 84 and 85.

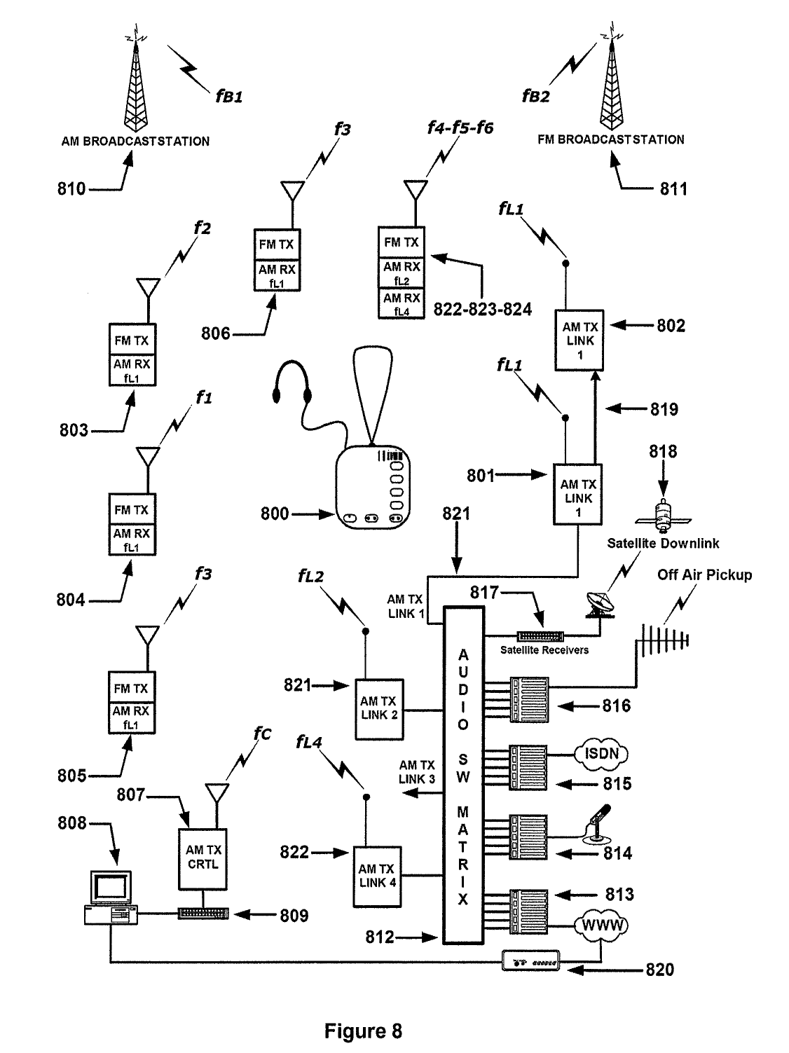

FIG. 8 illustrates an overall system implementation of the billboard receiver and broadcast system by exemplifying a plurality of broadcast mediums that can be wirelessly retransmitted to the billboard receiver within the confines a venue or sporting facility. Accordingly, while this invention has been described with reference to illustrative embodiments, this description is not intended to be construed in a limiting sense. Various modifications of the illustrative embodiments, as well as other embodiments of the invention will be apparent to persons skilled in the art upon reference to this description.

Billboard receiver 800 is symbolized in FIG. 8 as being in a confined venue and is in proximity of AM Control Channel Transmitter 807 which provides ubiquitous signal coverage within the venue. Transmitter 807 is a license-free AM broadcast band transmitter that transmits on an unoccupied standard broadcast band frequency at the venue location between 1340 KHz and 1710 KHz and is denoted as fc in FIG. 8. Transmitter 807 has its baseband input connected to a two-tone AFSK modulator 809 that modulates the control information that is being continually sent to it over a serial port connection from PC controller 808. Additional AM transmitters may be deployed in a simulcast configuration thereby providing scalable coverage of the of the control channel broadcasting on fc to a larger venue or geographical area.

PC controller 808 is a personal computer that runs the receiver remote configuration application program that continually sends the receivers 800 preset button parameters on frequency fc through a two-tone AFSK modulator 809 and AM transmitter 807. PC controller 808 contains a preconfigured database of parameters relating to each of the individual preset buttons on receiver 800 as to its operation within the current venue. The button frequency information parameters relating to the internal broadcast network may only be required to be programmed once as the frequencies of these repeaters remain fixed once they are determined. The control data consists of the assigned button number, the associated frequency or group frequencies, the band of operation AM or FM, the advertisement prompt addresses, stereo MPX decoder on/off and the baseband output switch configuration.

In FIG. 8 transmitters 803 is fixed to frequency f2, transmitter 804 is fixed to frequency f1, transmitter 805 is fixed to frequency f3, and transmitter 806 is fixed to frequency f3 which is associated to one of the receiver 800 preset buttons. In the FIG. 8 example, receiver button one is assumed to have been assigned via the control channel fc the group frequencies f1, f2, f3, button two will be assigned frequency fB1, button 3 will be assigned fB2 and button 4 will be assigned frequency fL for explanatory purposes. Frequencies f1, f2, f3, and fL have been confirmed to be unoccupied broadcast band frequencies at the venues location.

Upon powering up of the billboard receiver 800, it will play out the initial greeting message through to the user headphones. While the greeting message is being played, the receiver 800 will automatically search, detect and lock onto the control channel transmitting on frequency fc. The receiver 800 will subsequently demodulate and store within memory all the related button parameter information that is repeatedly being sent over the control channel fc. Upon conclusion of the greeting message, the spectator will depress one of the program labeled preset buttons of their choice. If button number two was selected, the receiver 800 plays out the associated audio advertisement for the corresponding button selection. Upon completion of the audio advertisement the receiver 800 would be tuned to the event related program content being broadcasted on fixed frequency fB1 represented as an off-air AM broadcast station 810 located within the vicinity of the venue. The receiver 800 outputs to the user headphones the audio program being transmitted on frequency fB1.

If the spectator selected button three, the receiver 800 plays out the associated audio advertisement for the corresponding button selection. Upon completion of the audio advertisement the receiver 800 would be tuned to the event related program content being broadcasted on fixed broadcasted on fixed frequency fB2 represented as an off-air FM broadcast station 811 located within the vicinity of the venue. The receiver 800 outputs to the user headphones the audio program being transmitted on frequency fB2.

If the spectator selected the program relating to button one, receiver 800 plays out the associated audio advertisement for the corresponding button selection. During the audio advertisement receiver 800 invokes its group frequency switching algorithm which searches for the event related broadcast on frequencies f1, f2 and f3 and is represented as the unlicensed broadcast network in FIG. 8 by repeaters 803, 804, 805, 806 and 801 deployed within the venue. The receiver 800 may tune either to f1, f2, or f3 searching for a repeater frequency that provides a qualified signal level. The receiver 800 will be located in a signal coverage zone which is provided by one of the associated repeaters 803, 804, 805, and 806. Frequency reuse of f1, f2 and f3 permits scalable signal coverage by allowing additional repeaters to be strategically placed whereby adjacent zones differ in frequency as exampled by repeater 806 reusing frequency f3. As receiver 800 roams within the confines of the venue, its internal switching algorithm seamlessly switches between group frequencies f1, f2, and f3 by continually monitoring within the associated group of frequencies for a qualified signal level.

Program content transmitted by repeaters 803, 804, 805, and 806 respectively are received wirelessly from broadcast AM link transmitter 801. All associated repeaters 803, 804, 805, and 806 are tuned to a fixed receive frequency of fL1 from link transmitter 801. The link frequency coverage fL may be made scaleable with the use of a master timing synchronization signal 819 whereby an additional unlicensed transmitter 802 can be deployed to transmit on fL1 in a simulcast mode. A multiplicity of transmitters can use the synchronization signal from transmitter 801 for increasing the overall link coverage area.

Link transmitter 801 has its audio source 821 connected into audio switch matrix 812 which provides and selects the associated program that is labeled on preset button one. Audio Switch Matrix 812 is a 2 channel cross-point switch that allows the selection of a plurality of broadcast sources and mediums 813, 814, 815, 816 and 817 that can be switched to the corresponding link transmitters 801, 821, and 822 to match the printed button designations on billboard receivers 800 outside paper packaging. Audio matrix switch 812 can be administered remotely via the Internet though a term server 820 to switch in different program sources for a variety of venue events whereby the radio designations and package advertising may change to suit the event. The term server 820 through remote administration can also alter the fixed off-air button assignments on the PC controller 808 to match the receiver paper packaging button designations of the associated venue event. This allows different paper radio packaging to be used for dissimilar venue events without changing the fixed frequency assignments of the venues broadcast network. Also fewer program selection buttons are required on the billboard receiver itself 800.

Broadcast audio sources 817 that connect and input to switch matrix 812 represent various receivers that demodulate program content that originate from satellite based networks 818 including DARS (Digital Audio Radio Service), and FSS (Fixed Satellite Services) that may carry the venue event or related program content. Broadcast audio sources 816 that connect and input to switch matrix 812 represent local commercial AM, FM, broadcast band and Television receivers that re-amplify and demodulate off-air programs frequencies that might be marginal within the confines of the venue. These off-air signals are RF boosted and rebroadcast through frequency translation of the local unlicensed network.

Broadcast audio sources 815 that connect and input to switch matrix 812 inputs represent terrestrial program links such as ISDN (Integrated Services Digital Network), STL Lines (Studio Transmitter Links), Cable television demodulators and Broadcast Program lines that are related to the venues event. Broadcast audio sources 814 that connect and input to switch matrix 812 inputs represent audio content that originate and remain internal to the venue such as bench, referee, field and player microphones pickups. Broadcast audio sources 813 that connect and input to switch matrix 812 represent Internet related broadcast services such as Internet radio, IPTV and streaming webcasts that are related to the venues event.

An added possible variation of the billboard receiver 800 if button 4 is depressed, the receiver can be configured to receive unlicensed AM band frequencies and switch between a group of frequencies fL1, fL2 and fL4 searching for a non-repeated frequency that provides a qualified signal level. Switch matrix 820 would provide the same program content to all 3 switch outputs to AM band transmitters 801, 821, and 822. Due to the greater coverage of low power AM broadcast band, the receiver could even be configured just to switch to the fixed local AM broadcast frequency fL1 using a single or multiple transmitter configuration operated in simulcast. These receiver programming options would depend on the geographical size of the venue, the availability of unoccupied broadcast band spectrum as well as the receiver's intrinsic sensitivity. Operating the receiver in an AM frequency switched mode requires that the fixed program variables within the switching algorithm be changed. Different hysteresis values, RSSI levels, timing values are required which is mainly due to the capture effect, receiver sensitivity and improved S/N ratios inherent in the FM band.

Another possible variation of the billboard receiver where limited unoccupied FM broadcast spectrum is available is to transmit two preset button associated programs for receiver 800 over one set of group frequencies. Program associated content for receiver button one is switched through audio switch matrix 820 to AM link transmitter 821 broadcasting on frequency fL2. A different program associated with receiver button two is switched through audio switch matrix 820 to AM link transmitter 822 broadcasting on frequency fL4. Repeaters 822, 823, and 824 are transmitting on their respective group frequencies f4, f5, and f6. These repeaters are equipped with two AM receivers that are fixed to receive frequencies fL2 and fL4 and subsequently demodulate both link broadcast frequencies. The two demodulated baseband signals are inputted to the stereo audio left and audio right of the respective transmitters in each of the repeaters 822, 823, and 824.

PC controller 808 in this configuration sends via control channel fc the preset button information for program buttons one and two with the same group frequency assignments of f4, f5, and f6. However the baseband switching parameters sent will differ as when button one is selected and depressed, its switching parameter configures the baseband switch to select the left channel audio from receiver 800 to the user headphones. Button two will be sent baseband switching assignments instructing it to select the right channel audio of receiver 800 to the user headphones when selected and depressed.

If the spectator selected the program relating to button one, the receiver 800 plays out an audio advertisement associated with preset button one. During the audio advertisement receiver 800 subsequently invokes its group frequency switching algorithm which will search for the event related broadcast on frequencies f4, f5 and f6 and is represented as the unlicensed broadcast network in FIG. 8 by repeaters 822, 823 and 824, which is located within the venue. The receiver 800 is situated in a signal coverage zone provided by one of the associated repeaters 822, 823, and 824. The receiver 800 may tune either to f4, f5, or f6 searching for a repeater frequency that provides a qualified signal level. Following the audio advertisement the receiver 800 subsequently switches to the left channel output of receiver 800 providing the program content to the user headphones that originates from link transmitter 821 on fL2. As receiver 800 roams within the confines of the venue, its internal switching algorithm seamlessly switches between group frequencies f4, f5, and f6 by continually searching the frequency group for a qualified repeater signal.

If the spectator selected the program relating to button two, the receiver 800 plays out an audio advertisement associated with preset button two. During the advertisement receiver 800 subsequently invokes its group frequency switching algorithm which will search for the event related broadcast on frequencies f4, f5 and f6 and is represented as the unlicensed broadcast network in FIG. 8 by repeaters 822, 823 and 824, which is located within the venue. The receiver 800 is situated in a signal coverage zone provided by one of the associated repeaters 822, 823, and 824. The receiver 800 may tune either to f4, f5, or f6 searching for a repeater frequency that provides a qualified signal level. Following the audio advertisement the receiver 800 subsequently switches to the right channel output of receiver 800 providing the program content to the user headphones that originates from link transmitter 822 on fL4. As receiver 800 roams within the confines of the venue, its internal switching algorithm seamlessly switches between group frequencies f4, f5, and f6 by continually searching the frequency group for a qualified repeater signal.

If the receiver 800 does not find a qualified repeater signal (receiver is not located within the venue or is out of range of the localized broadcast network), the receiver will play out an audio prompt indicating to the user they are out of the geographical area of intended operation of the receiver.

Many modifications and other embodiments of the inventions set forth herein may come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

That which is claimed:

1. A billboard receiver comprising a layered structure including:
a first layer comprising a receiver portion including a radio receiver configured to be tunable to a selected one of a plurality of predefined radio programs via a corresponding one of a plurality of predetermined selection switch mechanisms; and
a second layer defining a billboard portion, the billboard portion including at least a first substrate comprising the second layer, the first substrate positioned to substantially cover at least one side of the receiver portion.

2. The billboard receiver of claim 1, wherein the billboard portion further comprises a third layer comprising a second substrate, the first and second substrates being positioned substantially opposite of each other with respect to the receiver portion in order to substantially enclose the receiver portion.

3. The billboard receiver of claim 2, wherein the billboard portion includes a visual advertisement on at least one of the first substrate or the second substrate.

4. The billboard receiver of claim 3, wherein the billboard portion includes a barcode or coupon exchangeable for value to a particular entity associated with the visual advertisement.

5. The billboard receiver of claim 1, wherein the billboard portion further includes visual indication portions corresponding to each of the predetermined selection switch mechanisms of the receiver portion.

6. The billboard receiver of claim 5, wherein each of the visual indication portions provides a visual indication of the corresponding program available via selection of each of the selection switch mechanisms.

7. The billboard receiver of claim 1, wherein each of the selection switch mechanisms corresponds to a predetermined frequency or group of frequencies carrying a corresponding one of the predefined radio programs.

8. The billboard receiver of claim 1, wherein each of the predefined radio programs may be remotely programmed wirelessly.

9. The billboard receiver of claim 2, wherein the first substrate and the second substrate are comprised of paper.

10. The billboard receiver of claim 2, wherein first substrate and the second substrate are comprised of a thin plastic film.

11. The billboard receiver of claim 1, wherein each of the predefined radio programs may be automatically programmed based on a particular geographical area corresponding to the area in which the billboard receiver is to be used.

12. The billboard receiver of claim 1, wherein at least one of the predefined radio programs corresponds to an off air broadcast program and at least another one of the predefined radio programs corresponds to a license-free transmission.

13. The billboard receiver of claim 1, wherein the receiver portion includes a processing element configured to execute a switching algorithm to enable handoff of the billboard receiver in a multiple transmitter environment or multiple repeater environment due to mobility of the billboard receiver, the handoff occurring in a broadcast environment.

14. The billboard receiver of claim 1, wherein the receiver portion includes a processing element configured to execute a switching algorithm to enable frequency switching of the billboard receiver based on a parameter.

15. The billboard receiver of claim 14, wherein the switching algorithm provides for switching based on a received signal strength indicator value.

16. The billboard receiver of claim 15, wherein the switching algorithm further provides for switching based on a timer value.

17. The billboard receiver of claim 16, wherein the switching algorithm further provides for a hysteresis value associated with the received signal strength indicator value, the timer value, or a frequency domain value.

18. The billboard receiver of claim 1, wherein the receiver portion includes an amplitude modulation (AM) band or a frequency modulation (FM) band receiver.

19. The billboard receiver of claim 1, wherein the receiver portion includes an amplitude modulation (AM) band and a frequency modulation (FM) band receiver.

20. The billboard receiver of claim 1, wherein the receiver portion includes at least one program identified via a pilot signal.

21. The billboard receiver of claim 1, wherein the receiver portion is configured to operate in at least two different frequency switching modes.

22. The billboard receiver of claim 1, wherein the receiver portion is configured to automatically tune to a frequency associated with a selected predefined radio program.

23. The billboard receiver of claim 22, wherein the receiver portion is configured to audibly render a prerecorded advertisement in response to tuning to the frequency prior to providing content corresponding to the selected predefined radio program.

24. The billboard receiver of claim 1, wherein the receiver portion is configured to audibly render a prerecorded advertisement in response to initial power up of the billboard receiver prior to providing content corresponding to the selected predefined radio program.

25. The billboard receiver of claim 1, wherein the receiver portion is configured to receive information corresponding to band assignment, switching parameters, frequency preset assignments, or audio advertisement association.

26. The billboard receiver of claim 1, wherein the receiver portion is configured to enable a provision of multiple content sources related to a particular event via the predefined radio programs.

27. The billboard receiver of claim 1, wherein the billboard receiver has no band indicator and no tuned frequency indicator.

28. The billboard receiver of claim 1, wherein the receiver portion is configured to conduct a baseband switch to receive alternative content at a given predefined radio program channel without a radio frequency shift.

29. The billboard receiver of claim 1, wherein the receiver portion includes at least a second receiver and wherein frequency switching characteristics are dependent upon a number of receivers employed in the receiver portion.

30. A license-free broadcast system comprising:
a billboard receiver having a layered structure including a first layer comprising a receiver portion including a radio receiver configured to be tunable to a selected one of a plurality of predefined radio programs via a corresponding one of a plurality of predetermined selection switch mechanisms, and at least a second layer defining a billboard portion, the billboard portion including at least a first substrate comprising the second layer, the first substrate positioned to substantially cover at least one side of the receiver portion; and
a transmit portion configured to transmit at least the plurality of predefined radio programs to the billboard receiver at a power density corresponding to license-free operation.

31. The system of claim 30, wherein the billboard portion further comprises a third layer comprising a second substrate, the first and second substrates being positioned substantially opposite of each other with respect to the receiver portion in order to substantially enclose the receiver portion

32. The system of claim 30, wherein the transmit portion includes a plurality of repeaters configured to cover an area corresponding to a particular venue.

33. The system of claim 32, wherein geographically adjacent repeaters operate at different frequencies.

34. The system of claim 33, wherein the transmit portion utilizes license-free amplitude modulation (AM) broadcast band transmission.

35. The system of claim 33, wherein the transmit portion utilizes license-free frequency modulation (FM) broadcast band transmission.

36. The system of claim 33, wherein the transmit portion utilizes license-free amplitude modulation (AM) broadcast band transmission for simulcasting.

37. The system of claim 33, wherein the transmit portion utilizes license-free frequency modulation (FM) broadcast band transmission for frequency translation.

38. The system of claim 33, wherein the transmit portion utilizes a 19 KHz pilot for providing an ability to conduct a baseband switch to access additional program content.

39. The system of claim 30, wherein the receiver portion is configured to enable a provision of multiple content sources related to a particular event via the predefined radio programs.

40. The system of claim 30, wherein the receiver portion is configured to enable reprogramming of content to match preset designations without a corresponding change of RF network topology.

41. A method comprising:
generating a billboard receiver having a layered structure including a first layer comprising a receiver portion including a radio receiver configured to be tunable to a selected one of a plurality of predefined radio programs via a corresponding one of a plurality of predetermined selection switch mechanisms, and at least a second layer defining a billboard portion, the billboard portion including at least a first substrate comprising the second layer, the first substrate positioned to substantially cover at least one side of the receiver portion; and
printing visual advertisement material for inclusion on at least one of the layers.

42. The method of claim 41, further comprising storing pre-recorded advertisement messages for playing in response to power up or program switching of the receiver portion.

43. The method of claim 42, wherein printing the visual advertisement comprises printing a visual advertisement that corresponds to at least a portion of the stored pre-recorded advertisement messages.
